(19) United States
(12) Patent Application Publication
(10) Pub. No.: US 2026/0191243 A1
(43) Pub. Date: Jul. 9, 2026

(54) GRANULAR FOOD AND METHOD OF MANUFACTURING SAME

(71) Applicant: SANYO FOODS CO., LTD., Tokyo (JP)

(72) Inventor: Hiroyuki NAGAOKA, Tokyo (JP)

(73) Assignee: SANYO FOODS CO., LTD., Tokyo (JP)

(21) Appl. No.: 19/556,877

(22) Filed: Mar. 4, 2026

Related U.S. Application Data
(62) Division of application No. 18/249,517, filed on Oct. 5, 2021.

(30) Foreign Application Priority Data
Oct. 23, 2020 (JP) 2020-177979
Jul. 12, 2021 (JP) 2021-115282

(51) Int. Cl. A23L 23/10; A23L 29/00; A23L 29/219; A23L 29/269; A23P 10/20; A23P 20/10

(52) U.S. Cl. CPC A23L 23/10; A23L 29/04; A23L 29/219; A23L 29/273; A23P 10/20; A23P 20/11

(57) ABSTRACT

Provided is a granular food that contains a fat or oil at a high concentration, yet has a high fluidity suitable for filling containers, and is capable of forming oil droplets when hot water is poured thereto. A granular food according to one embodiment of the present invention comprises (A) at least one fatty acid ester selected from the group consisting of a (poly)glycerol fatty acid ester having an average degree of polymerization in the glycerol moiety of 1-8 and a sucrose fatty acid ester having an HLB value of 8 or less, (B) a polyol, (C) a fat or oil and (D) a food material. In this granular food, the sum of angle of repose and angle of collapse is 87° or less and the compressibility is 15% or less.

This application is a divisional application of U.S. patent application Ser. No. 18/249,517, filed Apr. 18, 2023, which is a National Stage Application of PCT/JP2021/036859, filed Oct. 5, 2021, which claims benefit of priority to Japanese Application No. 2020-177979, filed Oct. 23, 2020 and Japanese Application No. 2021-115282, filed Jul. 12, 2021, which applications are incorporated herein by reference. To the extent appropriate, a claim of priority is made to each of the above disclosed applications.

### FIELD

The present disclosure relates to a granular food product and a method for the production thereof.

### BACKGROUND

Soup powder granulated by granulation is generally used for soup of instant foods such as instant cup noodles and instant cup soup. Soup powder having a small particle size tends to scatter when a container for instant food is filled therewith. The scattered soup powder may adhere to the inner wall of the container due to static electricity or moisture, or may make it difficult to control the filling amount in the filling process. Soup granules are less prone to these problems. For example, extrusion granulation and fluid bed granulation are known as methods for processing soup powder into granules.

By increasing the amount of liquid or semi-solid fat, the taste and palatability of instant foods can be enhanced. Powdery fat obtained by subjecting liquid fat to emulsification and spray drying or another drying method is generally known as a means for increasing the amount of fat. Since the liquid fat in the powdery fat is emulsified, substantially no oil droplets are generated on the surface of the soup even when hot water is added to the instant food. Thus, at the time of eating, the appearance of instant foods using powdery fat is different from ramen, soup, or the like provided at restaurants.

Soup granules containing a high concentration of fat using extrusion granulation are known for curry-taste soup of instant foods. However, since extrusion granulation involves a high temperature process, the seasoning oil tends to lose its aroma.

Attaching individually packaged liquid or semi-solid seasoning oil to an instant food in order to make the appearance at the time of eating of the instant food more similar to foods served at restaurants and to maintain the aroma of the seasoning oil is generally known. The individually packaged seasoning oil in a state of being adhered to the lid of the container of the instant food or sealed inside the container is shipped as a product and added to the instant food at the time of eating. However, since individual packaging of the seasoning oil requires additional packaging materials and man-hours, the production cost of the instant food is increased. Thus, soup granules containing fat at a high concentration are desired.
Patent Literature 1 (JP 2015-019589 A) describes a “powdery or granular seasoning composition comprising 5 to 30% by weight of a fat, a base material for fat incorporation, and a polyol.”
Patent Literature 2 (JP 2004-035700 A) describes a “powdery or granular fat which contains a fat, a base material for fat incorporation, and a polyol, wherein the water content is 15% by weight or less, the maximum particle size is 10 mm or less, the average particle size is 5 mm or less, and the angle of repose is 70° or less.”
Patent Literature 3 (JP 64-027430 A) describes a “powdery or granular fat-containing composition comprising a fat, a base material for fat incorporation, and a polyol, wherein the moisture content is 15% by weight or less, the maximum particle size is 10 mm or less, the average particle size is 5 mm or less, and the angle of repose is 70° or less.”
Patent Literature 4 (JP 59-166043 A) describes an “oil coating method for a powdery or granular material, wherein, using a batch mixer, a molten oil having a melting point of 30 to 70° C. and a solid fat index of 70 or more at room temperature is added to a heated powdery or granular material, mixed, and cooled.”

### CITATION LIST

### Patent Literature

[PTL 1] JP 2015-019589 A
[PTL 2] JP 2004-035700 A
[PTL 3] JP 64-027430 A
[PTL 4] JP 59-166043 A

### SUMMARY

### Technical Problem

When the concentration of fat contained in soup granules increases, the fat oozes out onto the surface of the soup granules, reducing the flowability of the soup granules as powder. Soup granules with low flowability may interfere with the filling process by forming bridges at the discharge port of a hopper or adhering to the inner wall of a hopper, whereby it is difficult to control the filling amount.

The present disclosure provides a granular food product which contains fat at a high concentration and has high flowability suitable for filling into containers, and can form fat oil droplets when hot water is added.

### Solution to Problem

The present inventor has discovered that by combining a specific fatty acid ester and a polyol, the flowability of a granular food product can be increased even when fat is contained at a high concentration, and have completed the present invention.

The present invention encompasses the following embodiments [1] to [18].

[1]

A granular food product, comprising:
(A) at least one fatty acid ester selected from the group consisting of a (poly)glycerin fatty acid ester having an average degree of polymerization of glycerin moieties of 1 to 8 and a sucrose fatty acid ester having an HLB of 8 or less,
(B) a polyol,
(C) a fat, and
(D) a food product raw material, wherein
the granular food product has a sum of an angle of repose and an angle of rupture of 87 degrees or less and a compressibility of 15% or less.
   [2]

The granular food product according to [1], wherein the sum of the angle of repose and the angle of rupture is 82 degrees or less and the compressibility is 12% or less.

[3]

The granular food product according to [1] or [2], wherein the (poly)glycerin fatty acid ester has a fatty acid moiety of 16 to 22 carbon atoms.

[4]

The granular food product according to any one of [1] to [3], wherein the (poly)glycerin fatty acid ester contains a mixture of a monoglycerin fatty acid ester and a polyglycerin fatty acid ester.

[5]

The granular food product according to any one of [1] to [4], wherein the sucrose fatty acid ester has a fatty acid moiety of 16 to 22 carbon atoms.

[6]

The granular food product according to any one of [1] to [5], wherein the sucrose fatty acid ester contains at least one selected from the group consisting of sucrose palmitate and sucrose stearate.

[7]

The granular food product according to any one of [1] to [6], wherein the polyol contains glycerin.

[8]

The granular food product according to any one of [1] to [7], wherein a content of the fatty acid ester is 0.2 mass % to 1.6 mass %.

[9]

The granular food product according to any one of [1] to [8], wherein a content of the fat is 1 mass % to 20 mass %.

[10]

The granular food product according to any one of [1] to [9], wherein a content of a dextrin compound is 10 mass % or less.

[11]

The granular food product according to any one of [1] to [10], wherein a total content of starch and modified starch is 10 mass % or less.

[12]

The granular food product according to any one of [1] to [11], wherein a melting point of the fatty acid ester is 50° C. or higher.

[13]

The granular food product according to any one of [1] to [12], wherein a mixture containing the fatty acid ester and the food product raw material is coated with a mixture containing the polyol and the fat.

[14]

The granular food product according to any one of [1] to [13], wherein the granular food product is soup granules.

[15]

A method for the production of a granular food product, comprising:
forming a granulated substance by granulating a mixture of (A) at least one fatty acid ester selected from the group consisting of a (poly)glycerin fatty acid ester having an average degree of polymerization of glycerin moieties of 1 to 8 and a sucrose fatty acid ester having an HLB of 8 or less and (D) a food product raw material, and
spraying a polyol dispersion oil containing (B) a polyol and (C) a fat onto the granulated substance.
   [16]

A method for the production of a granular food product, comprising:
forming a granulated substance by granulating (D) a food product raw material, and
spraying a polyol dispersion oil containing (A) at least one fatty acid ester selected from the group consisting of a (poly)glycerin fatty acid ester having an average degree of polymerization of glycerin moieties of 1 to 8 and a sucrose fatty acid ester having an HLB of 8 or less, (B) a polyol, and (C) a fat onto the granulated substance.
   [17]

A method for the production of a granular food product, comprising:
preparing a first mixture of (A) at least one fatty acid ester selected from the group consisting of a (poly)glycerin fatty acid ester having an average degree of polymerization of glycerin moieties of 1 to 8 and a sucrose fatty acid ester having an HLB of 8 or less, and (D) a food product raw material,
preparing a second mixture of a polyol dispersion oil containing (B) a polyol and (C) a fat and the first mixture, and
forming a granulated substance by granulating the second mixture.
   [18]

The method for the production of a granular food product according to [17], wherein the polyol dispersion oil further contains at least one additive selected from the group consisting of an extract and a paste-like seasoning.

### Advantageous Effects of Invention

According to the present invention, there is provided a granular food product which contains fat at a high concentration and which has high flowability suitable for filling into a container, and which can form oil droplets of the fat when hot water is added.

The above descriptions should not be considered to disclose all of the embodiments of the invention or all of the advantages associated with the present invention.

### DESCRIPTION OF EMBODIMENTS

In order to exemplify representative embodiments of the present invention, the present invention will be described in detail below, but the present invention is not limited to these embodiments.

### <Granular Food Product>

The granular food product according to an embodiment comprises (A) a fatty acid ester, (B) a polyol, (C) a fat, and (D) a food product raw material.

### (A) Fatty Acid Ester

The fatty acid ester is at least one selected from the group consisting of a (poly)glycerin fatty acid ester having an average degree of polymerization of glycerin moieties of 1 to 8 and a sucrose fatty acid ester having an HLB of 8 or less. Without being bound by any theory, it is believed that the fatty acid ester forms a network structure in the presence of liquid or semi-solid fat and incorporates the liquid or semi-solid fat into the network structure, thereby forming a gel or solid. It appears that the fat is roughly emulsified in the gel or solid. As a result, it is possible to increase the fat content of the granular food product and suppress the exudation of the fat, thereby imparting high flowability to the granular food product. Furthermore, the network structure of the fatty acid ester collapses in, for example, hot water at 90° C. to 100° C., releasing roughly emulsified, relatively large chunks of fat to the outside. This allows oil droplets of the fat to form when hot water is added to the granular food product.

The melting point of the fatty acid ester is preferably 50° C. or higher, more preferably 60° C. or higher, and further preferably 70° C. or higher. By setting the melting point of the fatty acid ester to 50° C. or higher, the granular food product can be imparted with moisture resistance while avoiding melting of the fatty acid ester. The melting point of the fatty acid ester is preferably 100° C. or lower, more preferably 90° C. or lower, and further preferably 80° C. or lower. By setting the melting point of the fatty acid ester to 100° C. or lower, cleaning of the interior of the piping during maintenance of the production equipment can easily be performed.

### <<(Poly)Glycerin Fatty Acid Ester>>

(Poly)glycerin fatty acid esters are esters of a fatty acid and glycerin or a glycerin condensate (polyglycerin). The average degree of polymerization of the glycerin moieties is 1 to 8. The (poly)glycerin fatty acid ester may be completely esterified or partially esterified. The fatty acid moiety of the (poly)glycerin fatty acid ester may be a saturated fatty acid or an unsaturated fatty acid. The fatty acid moiety of the (poly)glycerin fatty acid ester is preferably a saturated fatty acid.

The HLB of the (poly)glycerin fatty acid ester is preferably 8 or less, more preferably 6 or less, and further preferably 4 or less. Granular food products containing polyglycerin fatty acid esters having many lipophilic groups have high moisture resistance. From this point of view, the HLB of fatty acid ester can be 1 or more, or 3 or more. In the present disclosure, HLB is a value calculated from Griffin's empirical formula.

$$HLB = 20 \times ( 1 - SV / NV )$$

where SV: saponification value of the (poly)glycerin fatty acid ester or sucrose fatty acid ester; and
NV: neutralization value of the fatty acid

The number of carbon atoms of the fatty acid moiety of the (poly)glycerin fatty acid ester is preferably 16 to 22. Examples of the (poly)glycerin fatty acid ester include monoglycerin fatty acid esters such as monoglycerin palmitate, monoglycerin stearate, monoglycerin eicosanoate, and monoglycerin behenate; diglycerin fatty acid esters such as diglycerin palmitate, diglycerin stearate, diglycerin eicosanoate, and diglycerin behenate; triglycerin fatty acid esters such as triglycerin palmitate, triglycerin stearate, triglycerin eicosanoate, and triglycerin behenate; tetraglycerin fatty acid esters such as tetraglycerin palmitate, tetraglycerin stearate, tetraglycerin eicosanoate, and tetraglycerin behenate; pentaglycerin fatty acid esters such as pentaglycerin palmitate, pentaglycerin stearate, pentaglycerin eicosanoate, and pentaglycerin behenate; hexaglycerin fatty acid esters such as hexaglycerin palmitate, hexaglycerin stearate, hexaglycerin eicosanoate, and hexaglycerin behenate; heptaglycerin fatty acid esters such as heptaglycerin palmitate, heptaglycerin stearate, heptaglycerin eicosanoate, and heptaglycerin behenate; octaglycerin fatty acid esters such as octaglycerin palmitate, octaglycerin stearate, octaglycerin eicosanoate, and octaglycerin behenate; and mixtures of two or more of these. The (poly)glycerin fatty acid ester more preferably comprises a (poly)glycerin stearate having a fatty acid moiety of stearic acid (18 carbon atoms).

The (poly)glycerin fatty acid ester preferably contains a mixture of a monoglycerin fatty acid ester and a polyglycerin fatty acid ester, more preferably contains a mixture of monoglycerin behenate and octaglycerin stearate; a mixture of monoglycerin stearate, pentaglycerin palmitate and pentaglycerin stearate; or a mixture of monoglycerin stearate and diglycerin stearate, and particularly preferably contains a mixture of monoglycerin behenate and octaglycerin stearate. A mixture of a monoglycerin fatty acid ester and a polyglycerin fatty acid ester can improve the flowability of the granular food product, promote oil droplet formation during consumption, and embrace fat and spice extracts to retain taste.

### <<Sucrose Fatty Acid Ester>>

Sucrose fatty acid esters are esters of a fatty acid and sucrose. The HLB of the sucrose fatty acid ester is 8 or less. The sucrose fatty acid ester may be completely esterified or partially esterified. The fatty acid moiety of sucrose fatty acid ester may be a saturated fatty acid or an unsaturated fatty acid. The fatty acid moiety of the sucrose fatty acid ester is preferably a saturated fatty acid.

The HLB of the sucrose fatty acid ester is preferably 6 or less, and more preferably 4 or less. A granular food product containing a sucrose fatty acid ester having many lipophilic groups and few hydrophilic groups has high moisture resistance. From this point of view, the HLB of the sucrose fatty acid ester can be 1 or more, or 3 or more.

The number of carbon atoms of the fatty acid moiety of the sucrose fatty acid ester is preferably 16 to 22. Examples of sucrose fatty acid esters include sucrose palmitate, sucrose stearate, sucrose eicosanoate, and sucrose behenate. The sucrose fatty acid ester more preferably contains at least one selected from the group consisting of sucrose palmitate having a fatty acid moiety of palmitic acid (16 carbon atoms) and sucrose stearate having a fatty acid moiety of stearic acid (18 carbon atoms).

### (B) Polyol

A polyol is a compound having a plurality of alcoholic hydroxy groups, and has the ability to retain or release moisture (moisture retention) depending on the humidity of the environment. Without being bound by theory, by combining a polyol with a hydrophobic fat, the fat can become semi-solid or solid so that it can be retained in the granular food product.

The polyol is not particularly limited, and, for example, a non-toxic glycol, sugar, sugar alcohol, or combination of two or more thereof can be used. Examples of the non-toxic glycol include glycerin and propylene glycol. Examples of the sugar include sucrose and glucose. Examples of the sugar alcohol include sorbitol, xylitol, and mannitol. The polyol is preferably liquid at room temperature (23° C.). It is particularly preferable that the polyol comprise glycerin.

### (C) Fat

The fat is not particularly limited, and a vegetable oil, an animal fat, a processed fat, or a combination of two or more thereof can be used. Examples of the vegetable oil include soybean oil, rapeseed oil, palm oil, coconut oil, corn oil, cottonseed oil, sesame oil, rice oil, olive oil, safflower oil, peanut oil, grapeseed oil, perilla oil, linseed oil, camellia oil, evening primrose oil, herb oil, and chili oil. Examples of the animal fat include lard, beef fat, chicken fat, and fish oil. Examples of the processed fat include margarine, shortening, oil containing a medium chain fatty acid, monoglycerides, and diglycerides.

### (D) Food Product Raw Material

The food product raw material is the main ingredient which determines the taste and flavor of the granular food product, and is generally a mixture containing a crystalline substance and a powdery raw material.

Examples of the crystalline substance include salts, granulated sugar, monosodium glutamate, sodium inosinate, disodium succinate, glucose, and disodium ribonucleotides. It is preferable that the crystalline substance be finely pulverized.

The powdery raw material generally contains a taste ingredient. Taste ingredients are elements which impart taste (palate) or aroma (smell) to a food. Examples of the taste ingredient include general seasonings such as salt and sugar; fermented seasonings such as soy sauce, vinegar, mirin, and miso; spices such as garlic, ginger, pepper, laurel, thyme, and sage; extracts such as meat extract, seafood extract, and vegetable extract; acidulants such as citric acid, malic acid, acetic acid, and lactic acid; and seasonings such as amino acids, nucleic acids, organic acids other than acidulants, inorganic salts, yeast extracts, protein hydrolysates, and nucleic acid hydrolysates. The powdery raw material may further comprise a spice, essence, stabilizer (e.g., sodium caseinate or xanthan gum), emulsifier, or antioxidant, or combination of two or more thereof.

### <<Sum of Angle of Repose and Angle of Rupture>>

The sum of the angle of repose and the angle of rupture of the granular food product is 87 degrees or less. The sum of the angle of repose and the angle of rupture of the granular food product is preferably 82 degrees or less, and more preferably 80 degrees or less. By controlling the sum of the angle of repose and the angle of rupture to 87 degrees or less, the granular food product can be imparted with flowability suitable for filling into a container. The angle of repose and the angle of rupture are determined using a powder characterizer at room temperature (23° C.) in accordance with the following procedure. The granular food product is dropped through a funnel having an outlet height of 12 cm and an outlet inner diameter of 7 mm onto a disk having a diameter of 8 cm, and the angle of the base of the pile formed by the granular food product is defined as the angle of repose, and the angle of the base after impacting the pile three times is defined as the angle of rupture.

### <<Compressibility>>

The compressibility of the granular food product is 15% or less. The compressibility of the granular food product is preferably 12% or less, and more preferably 10% or less. By controlling the compressibility to 15% or less, the filling amount of the granular food product can precisely be controlled. Compressibility is determined using a powder characterizer at room temperature (23° C.) in accordance with the following procedure. The outlet of a funnel (outlet inner diameter: 7 mm) is aligned at a height of 38 cm from the upper surface of a cylindrical container having an inner diameter of 40 mm, a height of 80 mm, and a volume of 100 cm³. When approximately 120 cm³ of the granular food product is placed in the funnel and dropped, the mass of the granular food product filled in the cylindrical container is defined as a loose bulk density a (g/100 cm³). Then, a cap for replenishment is attached to the cylindrical container. When the granular food product is dropped in the same manner as in the measurement of the loose bulk density a, the container is tapped ten times to densify the soup granules, the cap is then removed, and after scraping off the surplus granular food product protruding from the upper surface of the cylindrical container, the mass of the soup granules filled in the cylindrical container is defined as a solidified bulk density b (g/100 cm³). The value obtained from the formula: (b−a)×100/b is defined as the compressibility.

The average particle size D₅₀ of the granular food product can be 30 μm to 1600 μm, 40 μm to 1500 μm, or 50 μm to 1400 μm. In the present disclosure, the average particle size D₅₀ of a powder or granules is the cumulative volume median diameter determined using a laser diffraction scattering method.

The content of the fatty acid ester in the granular food product is preferably 0.2 to 1.6 mass %, more preferably 0.4 to 1.6 mass %, and further preferably 0.8 to 1.2 mass %.

In an embodiment, the fatty acid ester content of the granular food product is determined in accordance with the fat content of the granular food product. For example, in the fat content range of 6 to 8 mass %, the fatty acid ester content is preferably in the range of 0.2 to 1.6 mass %, and in the fat content range of 15 to 20 mass %, the fatty acid ester content is preferably in the range of 0.8 to 1.6 mass %.

The content of the polyol in the granular food product is preferably 0.5 to 2.2 mass %, more preferably 0.6 to 1.9 mass %, and further preferably 0.7 to 1.6 mass %.

The fat content of the granular food product is preferably 1 to 20 mass %, more preferably 1 to 19 mass %, further preferably 1 to 16 mass %, and particularly preferably 1 to 12 mass %. The fat content varies with the type of food product raw material, fatty acid ester, and fat.

The content of the food product raw material of the granular food product is generally 79 to 99 mass %, preferably 82 mass % to 98.3 mass %, and more preferably 86.5 mass % to 98 mass %.

In the granular food product, the content of a dextrin compound is preferably 10 mass % or less, more preferably 5 mass % or less, and further preferably 1 mass % or less. By setting the content of the dextrin compound within the above range, delicate taste and flavor which may be spoiled by the artificial odor of the dextrin compound can be retained.

In the granular food product, the total content of starch and modified starch is preferably 10 mass % or less, more preferably 5 mass % or less, and further preferably 1 mass % or less. By setting the total content of starch and modified starch within the above range, the amount per serving (g/meal) can be suppressed while maintaining the taste and palatability.

The granular food product is preferably a mixture which contains the fatty acid ester and the food product raw material and which is coated with a mixture containing the polyol and the fat. By adopting such a structure in the granular food product, the formation of oil droplets when hot water is added to the granular food product can be further promoted.

### <Method 1 for Production of Granular Food Product>

The method for the production of a granular food product according to a first embodiment comprises forming a granulated substance by granulating a mixture of (A) at least one fatty acid ester selected from the group consisting of a (poly)glycerin fatty acid ester having an average degree of polymerization of glycerin moieties of 1 to 8 and a sucrose fatty acid ester having an HLB of 8 or less, and (D) a food product raw material, and spraying a polyol dispersion oil containing (B) a polyol and (C) a fat onto the granulated substance.

### <<Formation of Granulated Substance>>

A mixture can be prepared by mixing the fatty acid ester with the food product raw material using a mixing device such as a conical blender, a Nauta mixer, or a ribbon mixer. The ingredients of the food product raw material can also be premixed using a mixing device such as a conical blender, a Nauta mixer, or a ribbon mixer to prepare a premix, and the premix can then be mixed with the fatty acid ester.

The method for forming a granulated substance is not particularly limited, and examples thereof include fluidized bed granulation and extrusion granulation. Fluidized bed granulation can be preferably used for the formation of the granulated substance. In fluidized bed granulation, a binder for aggregating the powder by liquid-crosslinking may be sprayed onto the mixture while suspending the mixture in a powder state. Examples of spraying methods include top spraying, bottom spraying, and tangential spraying. Examples of the binder include water, polysaccharide thickeners (guar gum, locust bean gum, xanthan gum, etc.), starch, corn syrup, carboxymethylcellulose (CMC), and gelatin. Polysaccharide thickeners, starch, corn syrup, CMC and gelatin are generally sprayed in the form of an aqueous solution. The compressibility of the granulated substance can be enhanced by liquid-crosslinking the powder with the binder. By increasing the compressibility of the granulated substance, weighing errors in automatic cup filling using a stroke feeder can be reduced. The amount of binder used can be 0.04 parts by mass to 0.05 parts by mass on the pilot scale and 0.08 parts by mass to 0.1 parts by mass on the actual scale relative to the total 100 parts by mass of the fatty acid ester and the food product raw material.

In fluidized bed granulation, the granulated substance tends to have a broader particle size distribution or a lower density. Thus, after granulation, a vibrating sieve or the like may be used to remove large-sized granules, and the compressibility of the granulated substance may be enhanced by heating the granulated substance to reduce the moisture content.

The average particle size D₅₀ of the granulated substance is preferably 20 μm to 1400 μm, and more preferably 30 μm to 1300 μm. By setting the average particle size of the granulated substance to 20 μm or more and 1400 μm or less, the compressibility of the granular food product can be further reduced.

The compressibility of the granulated substance is preferably 11% or less, and more preferably 8% or less. By setting the compressibility of the granulated substance to 11% or less, the compressibility of the granular food product can be reduced.

### <<Spraying of Polyol Dispersion Oil>>

Next, a polyol dispersion oil containing the polyol and the fat is sprayed onto the resulting granulated substance.

The polyol dispersion oil can be prepared using a conventional stirrer or homogenizer. For example, when using a tank having an inner diameter of 476 mm (product number SPTL, manufactured by Shiro Sangyo Co., Ltd.) as an actual machine scale, the stirring blade (diameter 135 mm) of a tornado stirrer (Product name: TORNADO, turbine type T-125, stirring shaft: 50 cm, manufactured by AS ONE Corporation) is placed in the center of the tank so that the gap from the inner wall of the tank to the tip of the stirring blade is 170 mm and the height from the bottom of the tank is 5 to 10 mm. When using a 3 L glass beaker (manufactured by AGC Techno Glass Co., Ltd.) having an inner diameter of 165 mm as a pilot scale, the stirring blade (diameter 65 mm) of a tornado stirrer (product name: TORNADO, propeller type P-65, stirring shaft: 50 cm, manufactured by AS ONE Corporation) is placed in the center of the beaker so that the gap from the inner wall of the beaker to the tip of the stirring blade is 50 mm and the height from the bottom of the beaker is 2 to 5 mm.

A two-layer system of the polyol and the fat becomes a uniform dispersion system by, for example, stirring at a rotation speed of 400 to 450 rpm for a stirring time of 10 to 20 minutes. The polyol concentration in the polyol dispersion oil is preferably 7 to 12 mass %, more preferably 8 to 11 mass %, and further preferably 9 to 10 mass %. Specifically, for example, the polyol dispersion oil can be prepared by the following procedure. The stirring blade of a tornado stirrer is affixed in the center of a tank at a height of 5 to 10 mm from the bottom of the tank. Mixing is carried out at 400 to 450 rpm to prevent foaming. While continuing to stir the polyol dispersion oil obtained by stirring for 10 to 15 minutes, the polyol dispersion oil may be supplied to the spraying process via a tubular roller feeding liquid metering pump.

When glycerin is used as the polyol and the polyol concentration is 9.0 to 10 mass %, the specific gravity of the polyol dispersion oil is preferably 0.934 to 0.941. It appears that the higher the specific gravity of the dispersed oil, the more uniformly the glycerin is dispersed in the seasoning oil. By adjusting the stirring conditions to increase the specific gravity of the dispersion oil, a large amount of fat can be more effectively contained in the soup granules.

Since the polyol and the fat are incompatible with each other, the polyol in polyol dispersion oil will separate from the fat over time. Thus, preparation of the polyol dispersion oil begins before spraying. After preparing the polyol dispersion oil, it is preferable to use a tubular roller feeding metering pump to feed the polyol dispersion oil into the fluidized bed granulation machine and quickly spray it onto the granulated substance. The liquid feed rate can be, for example, 10 mL/min to 20 mL/min. The spraying conditions include, for example, a spray air pressure of 0.01 MPa to 0.02 MPa, a damper opening of 0.03 MPa to 0.05 MPa, and a nozzle diameter of 7 mm to 8 mm. The spraying of the polyol dispersion oil can be carried out using a conical ribbon mixing dryer as with a fluidized bed granulation machine.

The spraying of the polyol dispersion oil onto the granulated substance is preferably carried out at 55° C. to 70° C., and more preferably at 60° C. to 65° C. By setting the spraying temperature to 55° C. or higher, solidification of the fatty acid ester can be suppressed, and network formation of the fatty acid ester can be promoted. By setting the spraying temperature to 70° C. or lower, volatilization of the flavors in the fat can be suppressed, and a granular food product having an excellent flavor can be obtained.

Before spraying, the granulated substance may be further dried by, for example, maintaining the temperature of the granulated substance at 55° C. to 70° C. for 1 minute to 10 minutes, to increase the compressibility of the granulated substance.

By allowing the granular food product obtained after spraying of the polyol dispersion oil to stand for cooling, the network formation of the fatty acid ester and the semi-solidification or solidification of the fat by the polyol can be promoted. After being allowed to stand for cooling, large-sized granules may be removed using a vibrating sieve or the like.

### <Method 2 for Production of Granular Food Product>

The method for the production of a granular food product according to a second embodiment comprises forming a granulated substance by granulating (D) a food product raw material, and spraying a polyol dispersion oil containing (A) at least one fatty acid ester selected from the group consisting of a (poly)glycerin fatty acid ester having an average degree of polymerization of glycerin moieties of 1 to 8 and a sucrose fatty acid ester having an HLB of 8 or less, (B) a polyol, and (C) a fat onto the granulated substance.

### <<Formation of Granulated Substance>>

The food product raw material can be prepared by mixing the ingredients of the food product raw material using a mixing device such as a conical blender, a Nauta mixer, or a ribbon mixer.

The method for forming a granulated substance is not particularly limited, and examples thereof include fluidized bed granulation and extrusion granulation. Fluidized bed granulation can be preferably used for the formation of the granulated substance. In fluidized bed granulation, a binder for aggregating the powder by liquid-crosslinking may be sprayed onto the food product raw material while suspending the food product raw material in a powder state. Examples of spraying methods include top spraying, bottom spraying, and tangential spraying. Examples of the binder include water, polysaccharide thickeners (guar gum, locust bean gum, xanthan gum, etc.), starch, corn syrup, carboxymethylcellulose (CMC), and gelatin. Polysaccharide thickeners, starch, corn syrup, CMC and gelatin are generally sprayed in the form of an aqueous solution. The compressibility of the granulated substance can be enhanced by liquid-crosslinking the powder with the binder. By increasing the compressibility of the granulated substance, weighing errors in automatic cup filling using a stroke feeder can be reduced. The amount of binder used can be 0.04 parts by mass to 0.05 parts by mass on the pilot scale and 0.08 parts by mass to 0.1 parts by mass on the actual scale relative to the total 100 parts by mass of the fatty acid ester and the food product raw material.

In fluidized bed granulation, the granulated substance tends to have a broader particle size distribution or a lower density. Thus, after granulation, a vibrating sieve or the like may be used to remove large-sized granules, and the compressibility of the granulated substance may be enhanced by heating the granulated substance to reduce the moisture content.

The average particle size D₅₀ of the granulated substance is preferably 20 μm to 1400 μm, and more preferably 30 μm to 1300 μm. By setting the average particle size of the granulated substance to 20 μm or more and 1400 μm or less, the compressibility of the granular food product can be further reduced.

The compressibility of the granulated substance is preferably 11% or less, and more preferably 8% or less. By setting the compressibility of the granulated substance to 11% or less, the compressibility of the granular food product can be reduced.

### <<Spraying of Polyol Dispersion Oil>>

Next, the obtained granules are sprayed with a polyol dispersion oil containing the fatty acid ester, the polyol, and the fat.

The polyol dispersion oil can be prepared using a conventional stirrer. For example, when using a tank having an inner diameter of 476 mm (product number SPTL, manufactured by Shiro Sangyo Co., Ltd.) as an actual machine scale, the stirring blade (diameter 135 mm) of a tornado stirrer (Product name: TORNADO, turbine type T-125, stirring shaft: 50 cm, manufactured by AS ONE Corporation) is placed in the center of the tank so that the gap from the inner wall of the tank to the tip of the stirring blade is 170 mm and the height from the bottom of the tank is 5 to 10 mm. When using a 3 L glass beaker (manufactured by AGC Techno Glass Co., Ltd.) having an inner diameter of 165 mm as a pilot scale, the stirring blade (diameter 65 mm) of a tornado stirrer (product name: TORNADO, propeller type P-65, stirring shaft: 50 cm, manufactured by AS ONE Corporation) is placed in the center of the beaker so that the gap from the inner wall of the beaker to the tip of the stirring blade is 50 mm and the height from the bottom of the beaker is 2 to 5 mm.

The fatty acid ester, the polyol, and the fat can be uniformly dispersed by, for example, stirring at a rotation speed of 400 to 450 rpm for a stirring time of 10 to 20 minutes. The fatty acid ester can be dissolved in a small amount of the fat using a hot water bath or a microwave oven to achieve a 10 to 50 mass % fat mixture, and the remaining fat and polyol can be added to the fat mixture to prepare a polyol dispersion oil. The polyol concentration in the polyol dispersion oil is preferably 7 to 12 mass %, more preferably 8 to 11 mass %, and further preferably 9 to 10 mass %. The fatty acid ester concentration in the polyol dispersion oil is preferably 2.5 to 10 mass %, and more preferably 4 to 6 mass %. The fatty acid ester in the polyol dispersion oil helps maintain the dispersion of the incompatible polyol and fat.

The spraying of the polyol dispersion oil can be carried out in the same manner as in the method for the production of a granular food product according to the first embodiment. The spraying of the polyol dispersion oil can be carried out using a conical ribbon mixing dryer as with a fluidized bed granulation machine.

The spraying of the polyol dispersion oil onto the granulated substance is preferably carried out at 55° C. to 70° C., and more preferably at 60° C. to 65° C. By setting the spraying temperature to 55° C. or higher, solidification of the fatty acid ester can be suppressed, and network formation of the fatty acid ester can be promoted. By setting the spraying temperature to 70° C. or lower, volatilization of the flavors in the fat can be suppressed, and a granular food product having an excellent flavor can be obtained.

Before spraying, the granulated substance may be further dried by, for example, maintaining the temperature of the granulated substance at 55° C. to 70° C. for 1 minute to 10 minutes, to increase the compressibility of the granulated substance.

By allowing the granular food product obtained after spraying of the polyol dispersion oil to stand for cooling, the network formation of the fatty acid ester and the semi-solidification or solidification of the fat by the polyol can be promoted. After being allowed to stand for cooling, large-sized granules may be removed using a vibrating sieve or the like.

### <Method 3 for Production of Granular Food Product>

The method for the production of a granular food product according to a third embodiment comprises preparing a first mixture of (A) at least one fatty acid ester selected from the group consisting of a (poly)glycerin fatty acid ester having an average degree of polymerization of glycerin moieties of 1 to 8 and a sucrose fatty acid ester having an HLB of 8 or less, and (D) a food product raw material, preparing a second mixture of a polyol dispersion oil containing (B) a polyol and (C) a fat and the first mixture, and forming a granulated substance by granulating the second mixture.

### <<Preparation of First Mixture>>

The first mixture can be prepared by mixing the fatty acid ester with the food product raw material using a mixing device such as a conical blender, a Nauta mixer, or a ribbon mixer. The ingredients of the food product raw material can also be premixed using a mixing device such as a conical blender, a Nauta mixer, or a ribbon mixer to prepare a premix and the premix can be mixed with the fatty acid ester.

### <<Preparation of Second Mixture>>

Preparation of the polyol dispersion oil can be carried out in the same manner as in production method 1.

The polyol dispersion oil may contain at least one additive selected from the group consisting of extracts and paste-like seasonings. Extracts and paste-like seasonings impart eating-quality, flavor, taste, etc., to granular food products. In the present embodiment, the extract and paste-like seasoning contained in the polyol dispersion oil can be effectively applied to the granular food product along with the fat. Examples of the extract include sauces such as soy sauce and fish sauce, and meat extracts such as pork extract, beef extract and chicken extract, seafood extract, and vegetable extract. Examples of the paste-like seasoning include miso, sesame paste, and curry roux.

Next, the polyol dispersion oil and the first mixture are mixed to prepare the second mixture. The polyol dispersion oil can be placed in a container having a hole of a diameter of 1.0 to 4.0 mm at the bottom, and dripped from the container onto the first mixture. The mixing of the polyol dispersion oil and the first mixture can be carried out using a mixing device such as a conical blender, a Nauta mixer, a ribbon mixer, or a pin mixer. The mixing device is preferably a conical ribbon mixer or a pin mixer, and is more preferably a pin mixer.

Since the polyol and the fat are not compatible with each other, the polyol in polyol dispersion oil will separate from fat over time. Thus, it is preferable to mix the polyol dispersion oil with the first mixture immediately after preparation. The mixing time is preferably within 20 minutes, ad more preferably within 10 minutes.

### <<Formation of Granulated Substance>>

The method for forming a granulated substance from the second mixture is not particularly limited. Examples thereof include fluidized bed granulation and extrusion granulation.

In fluidized bed granulation, a binder for aggregating the powder by liquid-crosslinking may be sprayed onto the second mixture while suspending the second mixture in a powder state. Examples of spraying methods include top spraying, bottom spraying, and tangential spraying. Examples of the binder include water, polysaccharide thickeners (guar gum, locust bean gum, xanthan gum, etc.), starch, corn syrup, carboxymethylcellulose (CMC), and gelatin. Polysaccharide thickeners, starch, corn syrup, CMC and gelatin are generally sprayed in the form of an aqueous solution. The binder concentration in the binder aqueous solution is preferably 0.3 mass % to 0.6 mass %. The compressibility of the granulated substance can be enhanced by liquid-crosslinking the powder with the binder. By increasing the compressibility of the granulated substance, weighing errors in automatic cup filling using a stroke feeder can be reduced. The amount of binder used can be 0.04 parts by mass to 0.05 parts by mass on the pilot scale and 0.08 parts by mass to 0.1 parts by mass on the actual scale relative to the total 100 parts by mass of the fatty acid ester and the food product raw material. The binder is preferably sprayed at 55° C. or higher, and more preferably at 60° C. to 65° C. By setting the spraying temperature to 55° C. or higher, the network formation of the fatty acid ester can be promoted and the fat can be efficiently absorbed into the granular food product. By setting the spraying temperature to 65° C. or lower, volatilization of the flavors in the fat can be suppressed, and a granular food product having an excellent flavor can be obtained.

By allowing the granular food product obtained after granulation to stand for cooling, the network formation of the fatty acid ester and the semi-solidification or solidification of the fat by the polyol can be promoted. After being allowed to stand for cooling, large-sized granules may be removed using a vibrating sieve or the like.

The average particle size D₅₀ of the granulated substance is preferably 20 μm to 1400 μm, and more preferably 30 μm to 1300 μm. By setting the average particle size of the granulated substance to 20 μm or more and 1400 μm or less, the compressibility of the granular food product can be further reduced.

The compressibility of the granulated substance is preferably 11% or less, and more preferably 8% or less. By setting the compressibility of the granulated substance to 11% or less, the compressibility of the granular food product can be reduced.

### <Method for Usage of Granular Food Product>

The granular food product can be used in a variety of applications. Applications of the granular food product include soup granules, furikake, and seasonings for other foods such as snacks, french fries, and the like. The granular food product can be used particularly preferably as soup granules.

### EXAMPLES

The specific embodiments of the present disclosure will be exemplified in the Examples below, although the present invention is not limited thereto. All parts and percentages, including in the tables, are by mass unless otherwise specified.

### <Raw Materials>

The raw materials used in the present Examples are as follows.

### (A) Fatty Acid Ester

Fatty acid ester Ap (mixture of monoglycerin behenate and octaglycerin stearate)
Fatty acid ester Bp (mixture of monoglycerin stearate, pentaglycerin palmitate, and pentaglycerin stearate)
Fatty acid ester Cp (mixture of monoglycerin stearate and diglycerin stearate)
Fatty acid ester Ds (sucrose stearate)
Fatty acid ester Es (sucrose palmitate)
Fatty acid ester Fp (decaglycerin behenate)
S-28D (decaglycerin stearate, manufactured by Mitsubishi Chemical Foods Co., Ltd.)
M-10D (decaglycerin myristate, manufactured by Mitsubishi Chemical Foods Co., Ltd.)

### (B) Polyol

Glycerin (food additive glycerin, manufactured by Kao Corporation)

### (C) Fat

Soy sauce-based seasoning oil (rice salad oil: 83.8 mass %, essence/seasoning oil: 16.2 mass %)
Miso-based seasoning oil (total of lard, rice salad oil, and chili oil: 81.1 mass %, essence/seasoning oil: 18.9 mass %)
Salt-based seasoning oil (sesame oil: 91.7 mass %, essence/seasoning oil: 8.3 mass %)
Curry-based seasoning oil (lard: 96.1 mass %, essence/seasoning oil: 3.9 mass %)

### (D) Food Product Raw Material

S1 (soy sauce-based soup powder) (crystalline substance: 41.6 mass %, powdery raw material: 58.4 mass %)
S2 (soy sauce-based soup powder) (crystalline substance: 32.2 mass %, powdery raw material: 67.8 mass %)
M1 (miso-based soup powder) (crystalline substance: 49.4 mass %, powdery raw material: 50.6 mass %)
C1 (salt-based soup powder) (crystalline substance: 46.9 mass %, powdery raw material: 53.1 mass %)
K1 (curry-based soup powder) (crystalline substance: 35.8 mass %, powdery raw material: 64.2 mass %)

(Crystalline substance: salt, granulated sugar, monosodium glutamate, sodium inosinate, disodium succinate, glucose, disodium ribonucleotide, etc.; Powdery raw material: chicken extract, pork extract, soy sauce, garlic extract, ginger extract, fermented extract, etc.)

The compositions of the fatty acid esters Ap, Bp, Cp, Ds, Es, and Fp were analyzed using gel permeation chromatography (GPC) and gas chromatography (GC).

GPC measurement was performed using a gel permeation chromatograph analyzer (DGU-20A3/LC20AD/CBM-20A/SIL-20AHT/CTO-20AC/SPD-M20A/RID-10A/FRC-10A, manufactured by Shimadzu Corporation). The conditions were as follows.
Column: Shim-pack GPC-80M (length 300 mm×inner diameter 80 mm)
Detectors: Refractive Index Detector (RID) (fatty acid esters Ap, Cp, Ds, Es, and Fp), Photodiode Array Detector (PDA) (fatty acid ester Bp)
Column temperature: 40° C.
Mobile phase: tetrahydrofuran (THF)
Flow rate: 1 mL/min
Standard material: Shodex STANDARD (Type: SM-105, manufactured by Showa Denko K.K.)
Sample: Tetrahydrofuran (THF) solution, fatty acid ester concentration 1 g/L, membrane filter (composed of PTFE, 0.5 μm) filtration
Injection volume: 20 μL

GC measurement was performed using a gas chromatograph Agilent 7890B GC system (manufactured by Agilent Technologies). The conditions were as follows.
Column: DB-23 (manufactured by Agilent Technologies, φ0.25 mm×30 m, film thickness 0.25 μm)
Detector: Flame ionization detector (FID)
Inlet temperature: 250° C.
Detector temperature: 250° C.
Column temperature: 50° C. (maintained for 1 minute)→temperature increase 10° C./minute→170° C.→temperature increase 1.2° C./minute→210° C.
Sample introduction system: split (1:20)
Hydrogen gas flow rate: 35 mL/min
Air flow rate: 300 mL/min
Nitrogen flow rate (makeup): 20 mL/min
Helium gas (carrier gas) pressure: 115 kPa
Injection volume: 1 μL
Collection amount: 0.03615 to 0.04237 g
Final liquid volume: 3 mL

For fatty acid ester Ap, peaks were observed at weight average molecular weight (Mw) positions of 2719 to 3271 (10.782 minutes) and 826 to 878 (11.237 minutes) in GPC. In GC, it was confirmed that the fatty acid composition was C18:C22=56:38. Based on this information, using the molecular weight of glycerol or its polymer and the fatty acid, it was determined that fatty acid ester Ap was a mixture of monoglycerin behenate (molecular weight 755.25=92.09+340.58×2−18) and octaglycerin stearate (molecular weight 3008.72=610.58+284.48×9−18×9).

The compositions of fatty acid esters Bp, Cp, and Fp were determined in the same manner as fatty acid ester Ap, using the measurement results of GPC and GC, and the molecular weights of glycerol or its polymer and the fatty acid. For fatty acid esters Ds and Es, the molecular weight of sucrose was used instead of the molecular weight of glycerol or its polymer, and the compositions including the esterification rate were determined.

Table 1 shows the compositions and physical properties of the fatty acid esters used in the Examples.

TABLE 1

| | Fatty acid composition [%] | | | | | Main glycerin degree of polymerization | Melting point | |
|---|---|---|---|---|---|---|---|---|
| | C14 | C16 | C18 | C20 | C22 | (Esterification rate for Ds and Es) | [° C.] | HLB |
| Ap | — | 2.5 | 55.9 | 3.4 | 37.9 | Octo-(8) and mono-(1) mixture | 68 to 78 | 3.5 |
| Bp | — | 34.2 | 66.8 | — | — | Penta-(5) and mono-(1) mixture | 51.5 | 1.7 |
| Cp | 0.3 | 32.3 | 66.7 | 0.6 | — | Di-(2) and mono-(1) mixture | 61.5 | 6 |
| Ds | — | 30.9 | 69.1 | — | — | Approx. 99% (sucrose stearate) | 59 | Approx. 1 |
| Es | 0.5 | 82.8 | 16.7 | — | — | Approx. 99% (sucrose palmitate) | 61 | Approx. 1 |
| Fp | — | 0.3 | 2.7 | 7.7 | 87.3 | Deca-(10) single compound | 75 | 3 |

| | | | | |
|---|---|---|---|---|
| S-28D | Decaglycerin stearate | Deca-(10) single compound | 50 | 9 |
| M-10D | Decaglycerin myristate | Deca-(10) single compound | 22 | 15 |

### <Evaluation Methods>

The characteristics of soup granules were evaluated using the following methods.

### <<Compressibility>>

The compressibility of the soup granules was measured at room temperature (23° C.) using a powder characterization device (Powder Tester PT-X, manufactured by Hosokawa Micron Corporation). The sieve opening was set to 1700 μm or 4700 μm (only when the amount of seasoning oil sprayed was 140 mL or more). The outlet of the funnel (outlet inner diameter: 7 mm) was aligned at a height of 38 cm from the upper surface of a cylindrical container having an inner diameter of 40 mm, a height of 80 mm, and a volume of 100 cm³, and the loose bulk density a (g/100 cm³) was defined as the mass of the soup granules filled in the cylindrical container when approximately 120 cm³ of the soup granules were placed in a funnel and dropped. A cap for replenishment was attached to the same cylindrical container, the soup granules were dropped by the same procedure as the measurement of the loose bulk density a, the container was tapped ten times to make the soup granules dense, the cap was then removed, and after scraping off excess soup granules protruding from the upper surface of the cylindrical container, the mass of the soup granules filled in the cylindrical container was used as the solidified bulk density b (g/100 cm³ The compressibility was obtained from the formula: (b−a)×100/b.

### <<Angle of Repose and Angle of Rupture>>

The angle of repose and the angle of rupture of the soup granules were measured at room temperature (23° C.) using a powder characterization device (Powder Tester™ PT-X, manufactured by Hosokawa Micron Corporation). The sieve opening was set to 1700 μm or 4700 μm (only when the amount of seasoning oil sprayed was 140 mL or more). The soup granules were dropped onto a disk having a diameter of 8 cm through a funnel having an outlet height of 12 cm and an outlet inner diameter of 7 mm. The angle of the base of the pile formed by the soup granules was defined as the angle of repose, and the angle of the base after impacting the pile three times was defined as the angle of rupture. The value obtained by subtracting the angle of rupture from the angle of repose was used as the angle of difference. Tapping was performed with a stroke length of 18 mm (standard) and a tapping speed of 60 times/min.

### <<Carr Index>>

The information (loose bulk density, solidified bulk density, compressibility, angle of repose, angle of rupture, and angle of difference) obtained from the powder characterization device (Powder Tester™ PT-X, manufactured by Hosokawa Micron Corporation) can be indexed with reference to the flowability index table and the floodability index table (refer to Tohei Yokoyama et al., “Prototype of Powder Flowability Measuring Apparatus by Carr's Method”, Journal of Powder Technology, Vol. 6, No. 4 (1969), pp. 264-272). The sum of these indices plus the flowability index is the Carr index (=compressibility index+angle of repose index+flowability index+angle of rupture index+angle of difference index). The Carr index can be calculated using MT1001k analysis software Ver 1.02 (manufactured by Seishin Enterprise Co., Ltd.).

### <<Evaluation Based on Carr Index>>

The correlation between the number of cups having a filling amount outside the standard value and the Carr index was evaluated for the soup granules (including granulated substance) after cup filling. Specifically, after weighing 100 cups filled with the soup granules using a stroke feeder (speed: 29 shots/min), the number of cups which deviate from the standard value (median±1 g) was compared to the Carr index. As evaluation criteria, the case in which 5 or fewer cups were outside the standard value was evaluated as “excellent” (Carr index: 75 or more), the case in which 6 to 10 cups were outside the standard value was evaluated as “good” (Carr index: 70 or more and less than 75), the case in which 11 to 20 cups were outside the standard value was evaluated as “OK” (Carr index: 65 or more and less than 70), and the case in which 21 or more cups were outside the standard value was evaluated as “poor” (Carr index: less than 65).

### <<Evaluation by Compressibility, Angle of Repose, and Angle of Rupture>>

Examples in which the sum of the angle of repose and the angle of rupture was 87 degrees or less and the degree of compression was 15% or less are described as “Examples”, and otherwise are described as “Comparative Examples.” In the tables below, an evaluation of “excellent” based on the Carr index generally corresponds to a sum of angle of repose and angle of rupture of 82 degrees or less and a degree of compression of 12% or less. “Good” and “OK” ratings based on the Carr index generally correspond to sums of angle of repose and angle of rupture of 87 degrees or less and compression rates of 15% or less.

### 1. Types of Fatty Acid Esters and Presence or Absence of Polyol

The relationship between the type of fatty acid ester and the presence or absence of a polyol (glycerin) with the characteristics of the soup granules was investigated.

### Example 1

The soup granules were prepared in accordance with the following procedure.

### <<Premix Preparation>>

A premix was prepared by placing (D) Si (soy sauce-based soup powder) as a food product raw material and (A) fatty acid ester Ap into a conical blender (double cone mixer WM-20, manufactured by Seiwa Giken Co., Ltd.) and mixing. The crystalline substance of the (D) food product raw material was pulverized in advance with a pulverizer. The blending ratio of Si and fatty acid ester Ap was 99.16:0.84 (mass ratio).

### <<Fluidized Bed Granulation>>

The premix was placed onto a perforated plate of a fluidized bed coating device (flow coater, manufactured by Okawara Mfg. Co., Ltd.). The intake (air supply) temperature was set to 60° C., the damper opening was set to 0.03 MPa, and the spray air pressure was set to 0.18 MPa, and the powder was liquid-crosslinked to form granules by spraying, while suspending the premix, a 0.3 mass % aqueous solution of a thickening agent (guar gum, Orno SY-1, manufactured by Organo Food Tech Co., Ltd.) from a nozzle onto the premix. The granulated substance contained 0.04 to 0.05 mass parts of the thickening agent (solid content) per 100 mass parts of the premix. Thereafter, the intake air (supply) temperature was set to 70° C. and the granulated substance was dried for 4 to 6 minutes and cooled to room temperature. After cooling, large-sized granules were removed using a sieve (TESTING SIEVE (mesh opening: 2 mm, wire diameter: 0.9 mm), manufactured by Tokyo Screen Co., Ltd.). When the compressibility was 16% or more, the compressibility of the granulated substance was reduced by placing the obtained granules into a cone-shaped ribbon mixing and drying device (Ribocon RM-10D, manufactured by Okawara Mfg. Co., Ltd.), setting the temperature to 60 to 65° C., and stirring the mixture for 10 minutes to further remove moisture.

### <<Polyol Dispersion Oil Spraying>>

The granulated substance was placed onto a perforated plate of a fluidized bed coating device (flow coater, manufactured by Okawara Mgf. Co., Ltd.). A polyol dispersion oil (glycerin concentration 9 to 10 mass %) was prepared by adding glycerin as the (B) polyol to a soy sauce-based seasoning oil as the (C) fat and stirring at a rotation speed of 400 to 450 rpm for a stirring time of 10 minutes using a tornado stirrer (product name: TORNADO, turbine type T-125, stirring shaft: 50 cm, manufactured by AS ONE Co., Ltd.). Stirring was carried out by affixing the stirring blade at the center of the tank at a height of 5 to 10 mm from the bottom of the tank, and performing the stirring at a rotation speed of 400 to 450 rpm for 10 minutes or longer so as to not generate bubbles. Thereafter, using a tube-type roller feeding metering pump, the polyol dispersion oil was sprayed onto the granulated substance within 20 minutes (within 5 minutes at the earliest) after polyol dispersion oil preparation. The liquid feed rate was 12 mL/min (volume 10), the intake air temperature was 60° C., the damper opening was 0.03 to 0.05 MPa, and the spray air pressure was 0.01 to 0.02 MPa. Since glycerin and fat are not compatible with each other, the polyol in polyol dispersion oil separates from the fat over time, so stirring was continued until the end of spraying.

### Comparative Example 1

Soup granules were prepared by the same procedure as in Example 1, except that no fatty acid ester or glycerin was used.

### Comparative Example 2

Soup granules were prepared by the same procedure as in Example 1, except that no fatty acid ester was used.

### Examples 2 to 5 and Comparative Examples 3 to 5

Soup granules were prepared by the same procedure as in Example 1, except that the fatty acid ester was changed as shown in Table 2.

The details and characteristics of the soup granules of Examples 1 to 5 and Comparative Examples 1 to 5 are shown in Table 2.

TABLE 2

| | Food product | Fatty acid ester | | Polyol dispersion oil | | | | |
|---|---|---|---|---|---|---|---|---|
| | raw material | Type | Blend amt | Glycerin | Seasoning oil | | Spray amt | |
| Comp Ex 1 | S1 | — | — | — | 100.00% | Soy sauce-based | 53 mL | 7.70% |
| Comp Ex 2 | S1 | — | — | 9.80% | 90.20% | Soy sauce-based | 53 mL | 7.70% |
| Ex 1 | S1 | Ap | 0.84% | 9.80% | 90.20% | Soy sauce-based | 53 mL | 7.70% |
| Ex 2 | S1 | Bp | 0.84% | 9.80% | 90.20% | Soy sauce-based | 60 mL | 8.60% |
| Ex 3 | S1 | Cp | 0.84% | 9.80% | 90.20% | Soy sauce-based | 53 mL | 7.70% |
| Ex 4 | S1 | Ds | 0.84% | 9.80% | 90.20% | Soy sauce-based | 53 mL | 7.70% |
| Ex 5 | S1 | Es | 0.84% | 9.80% | 90.20% | Soy sauce-based | 53 mL | 7.70% |
| Comp Ex 3 | S1 | Fp | 0.84% | 9.80% | 90.20% | Soy sauce-based | 53 mL | 7.70% |
| Comp Ex 4 | S1 | S-28D | 0.84% | 9.80% | 90.20% | Soy sauce-based | 53 mL | 7.70% |
| Comp Ex 5 | S1 | M-10D | 0.84% | 9.80% | 90.20% | Soy sauce-based | 53 mL | 7.70% |

| | | | | |
|---|---|---|---|---|
| | | | Sum of angle of | |
| | Angle of repose | Angle of rupture | repose and angle of | |
| Compressibility | [degrees] | [degrees] | rupture [degrees] | Carr index |

| | | | | | | |
|---|---|---|---|---|---|---|
| Comp Ex 1 | 12.90% | 47.7 | 38.0 | 85.7 | 68.0 | OK |
| Comp Ex 2 | 11.02% | 45.4 | 37.2 | 82.6 | 73.0 | Good |
| Ex 1 | 7.54% | 44.1 | 32.2 | 76.3 | 82.0 | Excellent |
| Ex 2 | 9.73% | 43.5 | 37.5 | 81.0 | 75.5 | Excellent |
| Ex 3 | 12.85% | 45.9 | 35.0 | 80.9 | 75.5 | Excellent |
| Ex 4 | 10.60% | 42.6 | 34.0 | 76.6 | 78.0 | Excellent |
| Ex 5 | 8.37% | 43.2 | 36.5 | 79.7 | 76.3 | Excellent |
| Comp Ex 3 | 12.23% | 46.5 | 37.2 | 83.7 | 68.5 | OK |
| Comp Ex 4 | 3.63% | 46.0 | 41.9 | 87.9 | 70.5 | Good |
| Comp Ex 5 | 2.78% | 50.6 | 49.3 | 99.9 | 64.0 | Poor |

The decaglycerin fatty acid esters of Comparative Examples 3 to 5 were different in the number of carbon atoms of the fatty acid (Fp: behenic acid, melting point 75° C., HLB3; S-28D: stearic acid, melting point 50° C., HLB9; M-10D: myristic acid, melting point 22° C., HLB15). In Comparative Example 4 (S-28D) and Comparative Example 5 (M-10D), which had an HLB of 9 or more, the moisture resistance of the soup granules was remarkably poor, and the soup granules melted. Comparative Example 3 (Fp) had good moisture resistance, but the Carr index was not different from that of Comparative Example 1 (Carr index 68).

(Poly)glycerin fatty acid esters (Ap, Bp, and Cp) and sucrose fatty acid esters (Ds and Fs) having a melting point of 50° C. or higher and an HLB of 6 or less were evaluated as excellent based on the Carr index and exhibited good results.

### 2. Dispersion Oil Spraying Amount

The relationship between the difference in fatty acid ester and the amount of dispersion oil sprayed with the characteristics of the soup granules was investigated.

### Examples 6 to 27 and Comparative Example 10

Soup granules were prepared by the same procedure as in Example 1, except that the fatty acid esters listed in Table 3 were used and the amount of polyol dispersion oil sprayed was as shown in Table 3.

### Comparative Examples 6 to 9

Soup granules were prepared by the same procedure as in Example 1 except that the fatty acid esters described in Table 3 were used and the polyol dispersion oil was not sprayed.

The details and characteristics of the soup granules of Examples 6 to 27 and Comparative Examples 6 to 10 are shown in Table 3.

TABLE 3

| | Food product | Fatty acid ester | | Polyol dispersion oil | | | | | |
|---|---|---|---|---|---|---|---|---|---|
| | raw material | Type | Blend amt | Glycerin | Seasoning oil | | Spray amt | | |
| Ex 6 | S1 | Ap | 0.84% | 9.80% | 90.20% | Soy sauce-based | 53 | mL | 7.70% |
| Ex 7 | S1 | Ap | 0.84% | 9.80% | 90.20% | Soy sauce-based | 60 | mL | 8.60% |
| Ex 8 | S1 | Ap | 0.84% | 9.80% | 90.20% | Soy sauce-based | 80 | mL | 11.10% |
| Ex 9 | S1 | Ap | 0.84% | 9.80% | 90.20% | Soy sauce-based | 100 | mL | 13.50% |
| Ex 10 | S1 | Ap | 0.84% | 9.80% | 90.20% | Soy sauce-based | 120 | mL | 15.80% |
| Ex 11 | S1 | Ap | 0.84% | 9.80% | 90.20% | Soy sauce-based | 140 | mL | 18.00% |
| Comp Ex 6 | S1 | Bp | 0.84% | — | — | — | — | | — |
| Ex 12 | S1 | Bp | 0.84% | 9.80% | 90.20% | Soy sauce-based | 60 | mL | 8.60% |
| Ex 13 | S1 | Bp | 0.84% | 9.80% | 90.20% | Soy sauce-based | 80 | mL | 11.10% |
| Ex 14 | S1 | Bp | 0.84% | 9.80% | 90.20% | Soy sauce-based | 100 | mL | 13.50% |
| Ex 15 | S1 | Bp | 0.84% | 9.80% | 90.20% | Soy sauce-based | 120 | mL | 15.80% |
| Ex 16 | S1 | Bp | 0.84% | 9.80% | 90.20% | Soy sauce-based | 140 | mL | 18.00% |
| Comp Ex 7 | S1 | Cp | 0.84% | — | — | — | — | | — |
| Ex 17 | S1 | Cp | 0.84% | 9.80% | 90.20% | Soy sauce-based | 50 | mL | 7.30% |
| Ex 18 | S1 | Cp | 0.84% | 9.80% | 90.20% | Soy sauce-based | 60 | mL | 8.60% |
| Ex 19 | S1 | Cp | 0.84% | 9.80% | 90.20% | Soy sauce-based | 70 | mL | 9.90% |
| Ex 20 | S1 | Cp | 0.84% | 9.80% | 90.20% | Soy sauce-based | 80 | mL | 11.10% |
| Comp Ex 8 | S1 | Ds | 0.84% | — | — | — | — | | — |
| Ex 21 | S1 | Ds | 0.84% | 9.80% | 90.20% | Soy sauce-based | 50 | mL | 7.30% |
| Ex 22 | S1 | Ds | 0.84% | 9.80% | 90.20% | Soy sauce-based | 60 | mL | 8.60% |
| Ex 23 | S1 | Ds | 0.84% | 9.80% | 90.20% | Soy sauce-based | 70 | mL | 9.90% |
| Comp Ex 9 | S1 | Es | 0.84% | — | — | — | — | | — |
| Ex 24 | S1 | Es | 0.84% | 9.80% | 90.20% | Soy sauce-based | 50 | mL | 7.30% |
| Ex 25 | S1 | Es | 0.84% | 9.80% | 90.20% | Soy sauce-based | 60 | mL | 8.60% |
| Ex 26 | S1 | Es | 0.84% | 9.80% | 90.20% | Soy sauce-based | 70 | mL | 9.90% |
| Ex 27 | S1 | Es | 0.84% | 9.80% | 90.20% | Soy sauce-based | 80 | mL | 11.10% |
| Comp Ex 10 | S1 | Es | 0.84% | 9.80% | 90.20% | Soy sauce-based | 100 | mL | 13.50% |

| | | | | Sum of angle of | | |
|---|---|---|---|---|---|---|
| | | Angle of repose | Angle of rupture | repose and angle of | | |
| | Compressibility | [degrees] | [degrees] | rupture [degrees] | Carr index | |
| Ex 6 | 7.54% | 44.1 | 32.2 | 76.3 | 82.0 | Excellent |
| Ex 7 | 13.41% | 41.6 | 30.2 | 71.8 | 78.5 | Excellent |
| Ex 8 | 8.35% | 42.8 | 35.3 | 78.1 | 78.0 | Excellent |
| Ex 9 | 10.64% | 46.5 | 36.5 | 83.0 | 72.0 | Good |
| Ex 10 | 13.41% | 48.0 | 35.7 | 83.7 | 71.0 | Good |
| Ex 11 | 13.35% | 46.3 | 38.9 | 85.2 | 69.8 | OK |
| Comp Ex 6 | 6.96% | 40.8 | 33.1 | 73.9 | 80.0 | Excellent |
| Ex 12 | 9.73% | 43.5 | 37.5 | 81.0 | 75.5 | Excellent |
| Ex 13 | 11.21% | 42.0 | 36.2 | 78.2 | 74.5 | Good |
| Ex 14 | 11.34% | 43.3 | 39.3 | 82.6 | 71.5 | Good |
| Ex 15 | 11.91% | 42.7 | 36.4 | 79.1 | 71.0 | Good |
| Ex 16 | 14.76% | 47.9 | 38.7 | 86.6 | 67.0 | OK |
| Comp Ex 7 | 5.09% | 41.8 | 33.0 | 74.8 | 82.5 | Excellent |
| Ex 17 | 12.85% | 45.9 | 35.0 | 80.9 | 75.5 | Excellent |
| Ex 18 | 9.17% | 43.3 | 37.8 | 81.1 | 76.0 | Excellent |
| Ex 19 | 8.87% | 41.8 | 36.0 | 77.8 | 76.0 | Excellent |
| Ex 20 | 7.36% | 42.6 | 37.6 | 80.2 | 73.0 | Good |
| Comp Ex 8 | 4.41% | 41.6 | 31.7 | 73.3 | 83.0 | Excellent |
| Ex 21 | 10.60% | 42.6 | 34.0 | 76.6 | 78.0 | Excellent |
| Ex 22 | 7.09% | 43.5 | 35.9 | 79.4 | 78.0 | Excellent |
| Ex 23 | 13.45% | 45.8 | 37.1 | 82.9 | 73.0 | Good |
| Comp Ex 9 | 6.76% | 40.9 | 32.8 | 73.7 | 80.0 | Excellent |
| Ex 24 | 8.37% | 43.2 | 36.5 | 79.7 | 76.3 | Excellent |
| Ex 25 | 6.95% | 44.3 | 38.1 | 82.4 | 76.0 | Excellent |
| Ex 26 | 9.75% | 44.7 | 37.6 | 82.3 | 74.3 | Good |
| Ex 27 | 9.65% | 45.5 | 37.3 | 82.8 | 73.0 | Good |
| Comp Ex 10 | 15.53% | 50.9 | 41.6 | 92.5 | 62.5 | Poor |

Based on the results of “1. Types of Fatty Acid Esters and Presence or Absence of Polyol,” the amount of polyol dispersion oil sprayed onto the granulated substance containing fatty acid esters (Ap, Bp, Cp, Ds, and Fs) was increased. When 11.1 mass % of polyol dispersion oil was sprayed, Example 8 (Ap: mixture of monoglycerin behenate and octaglycerin stearate), Example 13 (Bp: mixture of monoglycerin stearate, pentaglycerin palmitate, and pentaglycerin stearate), and Example 20 (Cp: mixture of monoglycerin stearate and diglycerin stearate) exhibited good results. Good results were obtained in Examples 10 (Ap) and 15 (Bp) even when a large amount of polyol dispersion oil of 15.8 mass % was sprayed.

### 3. Blending Amount of Fatty Acid Ester

The relationship between the blending amount of a fatty acid ester and the characteristics of the soup granules was investigated.

### Examples 28 to 35

Soup granules were prepared by the same procedure as in Example 1, except that the blending amount of the fatty acid ester was as shown in Table 4.

### Comparative Examples 11 to 18

Soup granules were prepared by the same procedure as in Examples 28 to 35, except that the polyol dispersion oil was not sprayed.

The details and characteristics of the soup granules of Examples 28 to 35 and Comparative Examples 11 to 18 are shown in Table 4.

TABLE 4

| | Food | | | | | | | |
|---|---|---|---|---|---|---|---|---|
| | product | | | | | | | |
| | raw | Fatty acid ester | | Polyol dispersion oil | | | | |
| | material | Type | Blend amt | Glycerin | Seasoning oil | | Spray amt | |
| Comp Ex 11 | S1 | Ap | 0.10% | — | — | — | — | — |
| Ex 28 | S1 | Ap | 0.10% | 9.80% | 90.20% | Soy sauce-based | 53 mL | 7.70% |
| Comp Ex 12 | S1 | Ap | 0.20% | — | — | — | — | — |
| Ex 29 | S1 | Ap | 0.20% | 9.80% | 90.20% | Soy sauce-based | 53 mL | 7.70% |
| Comp Ex 13 | S1 | Ap | 0.40% | — | — | — | — | — |
| Ex 30 | S1 | Ap | 0.40% | 9.80% | 90.20% | Soy sauce-based | 53 mL | 7.70% |
| Comp Ex 14 | S1 | Ap | 0.80% | — | — | — | — | — |
| Ex 31 | S1 | Ap | 0.80% | 9.80% | 90.20% | Soy sauce-based | 53 mL | 7.70% |
| Comp Ex 15 | S1 | Ap | 1.20% | — | — | — | — | — |
| Ex 32 | S1 | Ap | 1.20% | 9.80% | 90.20% | Soy sauce-based | 53 mL | 7.70% |
| Comp Ex 16 | S1 | Ap | 1.60% | — | — | — | — | — |
| Ex 33 | S1 | Ap | 1.60% | 9.80% | 90.20% | Soy sauce-based | 53 mL | 7.70% |
| Comp Ex 17 | S1 | Ap | 2.00% | — | — | — | — | — |
| Ex 34 | S1 | Ap | 2.00% | 9.80% | 90.20% | Soy sauce-based | 53 mL | 7.70% |
| Comp Ex 18 | S1 | Ap | 2.40% | — | — | — | — | — |
| Ex 35 | S1 | Ap | 2.40% | 9.80% | 90.20% | Soy sauce-based | 53 mL | 7.70% |

| | | Angle of | Angle of | Sum of angle of | | |
|---|---|---|---|---|---|---|
| | | repose | rupture | repose and angle of | | |
| | Compressibility | [degrees] | [degrees] | rupture [degrees] | Carr index | |
| Comp Ex 11 | 4.87% | 41.7 | 33.8 | 75.5 | 81.0 | Excellent |
| Ex 28 | 5.71% | 46.2 | 39.5 | 85.7 | 73.3 | Good |
| Comp Ex 12 | 3.49% | 43.5 | 35.8 | 79.3 | 81.0 | Excellent |
| Ex 29 | 4.91% | 45.0 | 39.6 | 84.6 | 74.0 | Good |
| Comp Ex 13 | 6.76% | 40.9 | 32.8 | 73.7 | 80.0 | Excellent |
| Ex 30 | 9.30% | 46.2 | 34.5 | 80.7 | 80.0 | Excellent |
| Comp Ex 14 | 5.22% | 40.7 | 32.3 | 73.0 | 82.0 | Excellent |
| Ex 31 | 7.54% | 44.1 | 32.2 | 76.3 | 82.0 | Excellent |
| Comp Ex 15 | 4.85% | 39.7 | 33.2 | 72.9 | 81.8 | Excellent |
| Ex 32 | 8.72% | 46.2 | 34.7 | 80.9 | 80.0 | Excellent |
| Comp Ex 16 | 7.18% | 43.4 | 33.0 | 76.4 | 80.0 | Excellent |
| Ex 33 | 7.00% | 42.4 | 35.3 | 77.7 | 76.3 | Excellent |
| Comp Ex 17 | 7.51% | 39.7 | 33.9 | 73.6 | 78.5 | Excellent |
| Ex 34 | 9.65% | 42.6 | 38.4 | 81.0 | 72.5 | Good |
| Comp Ex 18 | 6.82% | 42.7 | 34.7 | 77.4 | 78.0 | Excellent |
| Ex 35 | 9.93% | 43.2 | 37.8 | 81.0 | 72.5 | Good |

Soup granules containing 0.2 to 1.6 mass % fatty acid ester Ap does not interfere with cup filling characteristics via a stroke feeder even when 7.7 mass % of polyol dispersion oil (corresponding to 7.0 mass % seasoning oil) is sprayed.

Referring to Comparative Examples 13 to 16 and Examples 30 to 33, there was substantially no difference in the Carr index between the granulated substance and the soup granules after spraying the dispersion oil (Comparative Examples 13 to 16: 80.0 to 82.0, Examples 30 to 33: 76.3 to 82.0). Most of the sprayed seasoning oil was contained in the granulated substance in the presence of glycerin and fatty acid ester Ap, and no seasoning oil bleeding was observed.

### 4. Blending Amount of Glycerin

The relationship between the blending amount of glycerin and the spraying amount of dispersion oil with the characteristics of soup granules was investigated.

### Examples 36 to 45 and Comparative Examples 19 to 21

Soup granules were prepared in the same manner as in Example 1, except that the food product raw material was changed to S2 (soy sauce soup powder), which was rich in powdery raw material, and the glycerin concentration and spraying amount in the polyol dispersion oil were as shown in Table 5.

The details and characteristics of the soup granules of Examples 36 to 45 and Comparative Examples 19 to 21 are shown in Table 5.

TABLE 5

| | Food product | Fatty acid ester | | Polyol dispersion oil | | | | |
|---|---|---|---|---|---|---|---|---|
| | raw material | Type | Blend amt | Glycerin | Seasoning oil | | Spray amt | |
| Ex 36 | S2 | Ap | 0.70% | 7.40% | 92.60% | Soy sauce-based | 120 mL | 15.80% |
| Ex 37 | S2 | Ap | 0.70% | 7.40% | 92.60% | Soy sauce-based | 140 mL | 18.00% |
| Comp Ex 19 | S2 | Ap | 0.70% | 7.40% | 92.60% | Soy sauce-based | 155 mL | 19.50% |
| Ex 38 | S2 | Ap | 0.70% | 9.80% | 90.20% | Soy sauce-based | 120 mL | 15.80% |
| Ex 39 | S2 | Ap | 0.70% | 9.80% | 90.20% | Soy sauce-based | 140 mL | 18.00% |
| Ex 40 | S2 | Ap | 0.70% | 9.80% | 90.20% | Soy sauce-based | 155 mL | 19.50% |
| Ex 41 | S2 | Ap | 0.82% | 7.40% | 92.60% | Soy sauce-based | 120 mL | 15.80% |
| Ex 42 | S2 | Ap | 0.82% | 7.40% | 92.60% | Soy sauce-based | 140 mL | 18.00% |
| Ex 43 | S2 | Ap | 0.82% | 7.40% | 92.60% | Soy sauce-based | 155 mL | 19.50% |
| Ex 44 | S2 | Ap | 0.82% | 10.40% | 89.60% | Soy sauce-based | 120 mL | 15.80% |
| Ex 45 | S2 | Ap | 0.82% | 10.40% | 89.60% | Soy sauce-based | 140 mL | 18.00% |
| Comp Ex 20 | S2 | Ap | 0.82% | 10.40% | 89.60% | Soy sauce-based | 155 mL | 19.50% |
| Comp Ex 21 | S2 | Ap | 0.82% | 10.40% | 89.60% | Soy sauce-based | 170 mL | 21.00% |

| | | Angle of | Angle of | Sum of angle of repose | | |
|---|---|---|---|---|---|---|
| | | repose | rupture | and angle of rupture | | |
| | Compressibility | (degrees] | [degrees] | [degrees] | Carr index | |
| Ex 36 | 8.88% | 46.7 | 37.3 | 84.0 | 72.5 | Good |
| Ex 37 | 9.78% | 47.5 | 38.5 | 86.0 | 72.0 | Good |
| Comp Ex 19 | 15.61% | 47.9 | 39.7 | 87.6 | 64.0 | Poor |
| Ex 38 | 6.80% | 43.6 | 34.8 | 78.4 | 79.5 | Excellent |
| Ex 39 | 8.62% | 46.2 | 38.8 | 85.0 | 74.3 | Good |
| Ex 40 | 11.44% | 46.2 | 35.4 | 81.6 | 74.0 | Good |
| Ex 41 | 8.58% | 45.2 | 34.6 | 79.8 | 80.5 | Excellent |
| Ex 42 | 9.73% | 47.5 | 36.5 | 84.0 | 74.5 | Good |
| Ex 43 | 10.28% | 46.7 | 36.5 | 83.2 | 72.5 | Good |
| Ex 44 | 7.55% | 42.0 | 35.5 | 77.5 | 76.3 | Excellent |
| Ex 45 | 7.47% | 45.9 | 36.9 | 82.8 | 77.5 | Excellent |
| Comp Ex 20 | 10.80% | 47.4 | 39.8 | 87.2 | 69.0 | OK |
| Comp Ex 21 | 12.40% | 50.1 | 45.9 | 96.0 | 58.0 | Poor |

The blending amount of the fatty acid ester Ap was fixed at 0.7 mass % or 0.82 mass %, the spraying amount of the polyol dispersion oil was increased from 7.7 mass % in Table 4 to 15.8 mass % to 21.0 mass %, and the glycerin concentration in the polyol dispersion oil was 7.4 mass % to 10.4 mass %.

Particularly good results were obtained in Examples 38 (Carr index 79.5), 41 (Carr index 80.5) and 44 (Carr index 76.3) when 15.8 mass % of polyol dispersion oil was sprayed. When 18.0 mass % of polyol dispersion oil was sprayed, particularly good results were obtained in Example 45 (fatty acid ester Ap: 0.82 mass %, glycerin concentration: 10.4 mass %, Carr index: 77.5).

### 5. Blending Amount of Glycerin and Rotation Speed During Stirring

Changes in the specific gravity of the polyol dispersion oil were investigated by changing the rotation speed during stirring. The specific gravity of glycerin is 1.2 to 1.3, and the specific gravity of the seasoning oil is 0.90 to 0.92. Glycerin and seasoning oil are not compatible with each other due to the difference in polarity and the difference in specific gravity described above, and the glycerin in the polyol dispersion oil will separate from the seasoning oil over time. Thus, it is desirable to evenly disperse the glycerin in the seasoning oil.

### Examples 46 to 54

Soup granules were prepared by the same procedure as in Example 1 except that the food product raw material was changed to M1 (miso-based soup powder), the blending amount of the fatty acid ester Ap was fixed at 0.84 mass %, and the rotation speed during stirring, the glycerin concentration in the polyol dispersion oil, and the spraying amount were as shown in Table 6. A polyol dispersion oil was prepared by placing the stirring blade (diameter 65 mm) of the tornado stirrer (product name: TORNADO, propeller type P-65 type, stirring shaft: 50 cm, manufactured by AS ONE Corporation) in the center of the beaker so that the gap from the inner wall of the beaker to the tip of the stirring blade was 50 mm and the height from the bottom of the beaker was 2 to 5 mm using a 3 L glass beaker (manufactured by AGC Techno Glass Co., Ltd.) having an inner diameter of 165 mm.

### Comparative Example 22

Soup granules were prepared by the same procedure as in Example 46, except that no polyol dispersion oil was sprayed.

The details and characteristics of the soup granules of Examples 46 to 54 and Comparative Example 22 are shown in Table 6. Table 6 shows the specific gravity of the polyol dispersion oil and the characteristics of soup granules after fixing the glycerin concentration in the polyol dispersion oil to 9.5 mass % or 11.5 mass % and stirring at 300 rpm, 400 rpm, or 450 rpm for 10 minutes.

TABLE 6

| | Food product | Polyol dispersion oil | | | | | | |
|---|---|---|---|---|---|---|---|---|
| | raw material | Revolution no. [rpm] | Specific gravity | Glycerin | Seasoning oil | | Spray amt | |
| Ex 46 | M1 | 300 | 0.9306 | 9.50% | 90.50% | Miso-based | 53 mL | 7.70% |
| Ex 47 | M1 | 400 | 0.9359 | 9.50% | 90.50% | Miso-based | 53 mL | 7.70% |
| Ex 48 | M1 | 450 | 0.9403 | 9.50% | 90.50% | Miso-based | 53 mL | 7.70% |
| Ex 49 | M1 | 300 | 0.9346 | 11.50% | 88.50% | Miso-based | 53 mL | 7.70% |
| Ex 50 | M1 | 400 | 0.9392 | 11.50% | 88.50% | Miso-based | 53 mL | 7.70% |
| Ex 51 | M1 | 450 | 0.9407 | 11.50% | 88.50% | Miso-based | 53 mL | 7.70% |
| Comp Ex 22 | M1 | — | — | — | — | — | — | — |
| Ex 52 | M1 | 450 | 0.9403 | 9.50% | 90.50% | Miso-based | 60 mL | 8.60% |
| Ex 53 | M1 | 450 | 0.9403 | 9.50% | 90.50% | Miso-based | 80 mL | 11.10% |
| Ex 54 | M1 | 450 | 0.9403 | 9.50% | 90.50% | Miso-based | 100 mL | 13.50% |

| | | Angle of repose | Angle of rupture | Sum of angle of repose and | | |
|---|---|---|---|---|---|---|
| | Compressibility | [degrees] | [degrees] | angle of rupture [degrees] | Carr index | |
| Ex 46 | 12.39% | 43.4 | 35.9 | 79.3 | 73.0 | Good |
| Ex 47 | 9.43% | 39.8 | 34.0 | 73.8 | 78.0 | Excellent |
| Ex 48 | 9.08% | 39.5 | 33.4 | 72.9 | 78.5 | Excellent |
| Ex 49 | 10.72% | 40.6 | 33.9 | 74.5 | 76.3 | Excellent |
| Ex 50 | 9.10% | 41.2 | 35.4 | 76.6 | 78.0 | Excellent |
| Ex 51 | 9.98% | 41.8 | 35.4 | 77.2 | 75.5 | Excellent |
| Comp Ex 22 | 5.22% | 38.9 | 32.3 | 71.2 | 82.3 | Excellent |
| Ex 52 | 9.64% | 40.8 | 34.2 | 75.0 | 77.8 | Excellent |
| Ex 53 | 9.67% | 40.2 | 34.6 | 74.8 | 78.0 | Excellent |
| Ex 54 | 9.14% | 40.6 | 35.7 | 76.3 | 75.0 | Excellent |

It appears that the higher the specific gravity of the dispersed oil, the more uniformly the glycerin is dispersed in the seasoning oil. By adjusting the stirring conditions to increase the specific gravity of the dispersion oil, a large amount of fat can more effectively be contained in the soup granules.

### 6. Effects of Glycerin and Fatty Acid Ester

The effects of the glycerin and the fatty acid ester were investigated.

### Comparative Examples 23 to 28

Soup granules were prepared by the same procedure as in Example 1, except that the fatty acid ester and the glycerin were not used and the spraying amount was as shown in Table 7.

### Comparative Examples 29 to 33

Soup granules were prepared by the same procedure as in Example 1, except that the fatty acid ester was not used and the spraying amount was as shown in Table 7.

### Examples 55 to 60

Soup granules were prepared by the same procedure as in Example 1, except that the amount of spraying was as shown in Table 7.

The details and characteristics of the soup granules of Examples 55 to 60 and Comparative Examples 23 to 33 are shown in Table 7.

TABLE 7

| | Food product | Fatty acid ester | Polyol dispersion oil | | | | |
|---|---|---|---|---|---|---|---|
| | raw material | Ap | Glycerin | Seasoning oil | Spray amt | | |
| Comp Ex 23 | S1 | — | — | 100% | 10 | mL | 1.50% |
| Comp Ex 24 | S1 | — | — | 100% | 20 | mL | 3.00% |
| Comp Ex 25 | S1 | — | — | 100% | 30 | mL | 4.50% |
| Comp Ex 26 | S1 | — | — | 100% | 40 | mL | 5.90% |
| Comp Ex 27 | S1 | — | — | 100% | 50 | mL | 7.30% |
| Comp Ex 28 | S1 | — | — | 100% | 60 | mL | 8.60% |
| Comp Ex 29 | S1 | — | 9.80% | 90.20% | 53 | mL | 7.70% |
| Comp Ex 30 | S1 | — | 9.80% | 90.20% | 60 | mL | 8.60% |
| Comp Ex 31 | S1 | — | 9.80% | 90.20% | 70 | mL | 9.90% |
| Comp Ex 32 | S1 | — | 9.80% | 90.20% | 80 | mL | 11.10% |
| Comp Ex 33 | S1 | — | 9.80% | 90.20% | 100 | mL | 13.50% |
| Ex 55 | S1 | 0.84% | 9.80% | 90.20% | 53 | mL | 7.70% |
| Ex 56 | S1 | 0.84% | 9.80% | 90.20% | 60 | mL | 8.60% |
| Ex 57 | S1 | 0.84% | 9.80% | 90.20% | 80 | mL | 11.10% |
| Ex 58 | S1 | 0.84% | 9.80% | 90.20% | 100 | mL | 13.50% |
| Ex 59 | S1 | 0.84% | 9.80% | 90.20% | 120 | mL | 15.80% |
| Ex 60 | S1 | 0.84% | 9.80% | 90.20% | 140 | mL | 18.00% |

| | | | | Sum of angle | | | | |
|---|---|---|---|---|---|---|---|---|
| | | | | of repose and | | | | |
| | | Angle of | Angle of | angle of | | | | |
| | | repose | rupture | rupture | Flowability | Floodability | | |
| | Compressibility | [degrees] | [degrees] | [degrees] | index | index | Carr index | |
| Comp Ex 23 | 13.30% | 45.0 | 34.1 | 79.1 | 36.0 | 40.0 | 76.0 | Excellent |
| Comp Ex 24 | 13.15% | 45.7 | 36.0 | 81.7 | 35.5 | 38.0 | 73.5 | Good |
| Comp Ex 25 | 14.85% | 46.2 | 37.0 | 83.2 | 34.5 | 37.5 | 72.0 | Good |
| Comp Ex 26 | 15.45% | 47.5 | 38.3 | 85.8 | 31.5 | 35.0 | 66.5 | OK |
| Comp Ex 27 | 16.51% | 48.7 | 38.3 | 87.0 | 30.0 | 34.0 | 64.0 | Poor |
| Comp Ex 28 | 17.64% | 50.8 | 40.3 | 91.1 | 30.0 | 34.0 | 64.0 | Poor |
| Comp Ex 29 | 11.02% | 45.4 | 37.2 | 82.6 | 37.0 | 36.0 | 73.0 | Good |
| Comp Ex 30 | 11.99% | 44.1 | 40.0 | 84.1 | 37.0 | 30.0 | 67.0 | OK |
| Comp Ex 31 | 11.15% | 44.5 | 39.7 | 84.2 | 37.0 | 30.0 | 67.0 | OK |
| Comp Ex 32 | 11.84% | 44.6 | 40.4 | 85.0 | 36.0 | 30.0 | 66.0 | OK |
| Comp Ex 33 | 8.54% | 46.5 | 45.0 | 91.5 | 35.0 | 27.0 | 62.0 | Poor |
| Ex 55 | 7.54% | 44.1 | 32.2 | 76.3 | 39.0 | 43.0 | 82.0 | Excellent |
| Ex 56 | 13.41% | 41.6 | 30.2 | 71.8 | 37.0 | 41.5 | 78.5 | Excellent |
| Ex 57 | 8.35% | 42.8 | 35.3 | 78.1 | 39.0 | 39.0 | 78.0 | Excellent |
| Ex 58 | 10.64% | 46.5 | 36.5 | 83.0 | 34.0 | 38.0 | 72.0 | Good |
| Ex 59 | 13.41% | 48.0 | 35.7 | 83.7 | 33.0 | 38.0 | 71.0 | Good |
| Ex 60 | 13.35% | 46.3 | 38.9 | 85.2 | 35.5 | 34.3 | 69.8 | OK |

When fatty acid ester Ap and glycerin are not used, soup granules containing a maximum of approximate 4.5 mass % of seasoning oil (Comparative Examples 23 to 28) can be prepared. The use of glycerin can slightly increase the seasoning oil content (Comparative Examples 29 to 33). Specifically, the use of glycerin improved the flowability index (=compressibility index+angle of repose index) (Comparative Example 29: 37.0, spraying amount: 7.7 mass %).

Conversely, when 7.7 mass % of the polyol dispersion oil was sprayed on a granulated substance containing 0.84 mass % of fatty acid ester Ap, the flowability index was improved to 39.0 and the floodability index (=flowability index+angle of rupture index+angle of difference index) was also significantly improved to 43.0 (Example 55). By combining fatty acid ester Ap and glycerin, soup granules containing a large amount of fat, 15.8 mass % to 18.0 mass %, can be prepared (Examples 59 and 60).

Without being bound by theory, glycerin is thought to improve the flowability index by, for example, solidifying the fat. Conversely, fatty acid ester Ap is thought to form a gel or solid by, for example, forming a network structure in the presence of the fat and incorporating the fat into the network structure. It is thought that the above two effects act synergistically to impart high flowability suitable for container filling to the soup granules containing a high concentration of fat.

### 7. Effect of Polyol Dispersion Oil Containing Fatty Acid Ester

The effect of a polyol dispersion oil containing the fatty acid ester on soup granules was investigated.

### Example 61

Soup granules were prepared by the same procedure as in Example 1, except that M1 (miso-based soup powder) was used as the food product raw material, and glycerin was mixed in the miso-based seasoning oil as fat as shown in Table 8.

### Examples 62 to 64

Soup granules were prepared by the same procedure as in Example 1, except that M1 (miso-based soup powder) was used as the food product raw material, and glycerin and fatty acid ester Bp were mixed in the miso-based seasoning oil as fat as shown in Table 8.

### Comparative Example 34

Soup granules were prepared by the same procedure as in Example 1, except that M1 (miso-based soup powder) was used as the food product raw material and the polyol dispersion oil was not sprayed.

The details and characteristics of the soup granules of Examples 61 to 64 and Comparative Example 34 are shown in Table 8.

TABLE 8

| | | | | Polyol dispersion oil | | | | | | |
|---|---|---|---|---|---|---|---|---|---|---|
| | Food product | Fatty acid ester | | Fatty acid ester | | | | | | |
| | raw material | Type | Blend amt | Type | Blend amt | Glycerin | Seasoning oil | | Spray amt | |
| Comp Ex 34 | M1 | Ap | 0.84% | — | — | — | — | — | — | — |
| Ex 61 | M1 | Ap | 0.84% | — | — | 9.50% | 90.50% | Miso-based | 60 mL | 8.60% |
| Ex 62 | M1 | Ap | 0.84% | Bp | 0.19% | 9.50% | 90.31% | Miso-based | 60 mL | 8.60% |
| Ex 63 | M1 | Ap | 0.84% | Bp | 0.22% | 9.50% | 90.28% | Miso-based | 60 mL | 8.60% |
| Ex 64 | M1 | Ap | 0.84% | Bp | 0.50% | 9.50% | 90.00% | Miso-based | 60 mL | 8.60% |

| | | | Angle of | Sum of angle of | | |
|---|---|---|---|---|---|---|
| | | Angle of repose | rupture | repose and angle of | | |
| | Compressibility | [degrees] | [degrees] | rupture [degrees] | Carr index | |
| Comp Ex 34 | 5.22% | 38.9 | 32.3 | 71.2 | 82.3 | Excellent |
| Ex 61 | 9.43% | 39.8 | 34.0 | 73.8 | 78.0 | Excellent |
| Ex 62 | 13.76% | 43.6 | 34.3 | 77.9 | 74.5 | Good |
| Ex 63 | 14.38% | 43.1 | 34.3 | 77.4 | 74.5 | Good |
| Ex 64 | 13.71% | 41.2 | 34.5 | 75.7 | 74.8 | Good |

When 0.84 mass % of fatty acid ester Ap was mixed in the food product raw material and 0.19 mass % to 0.50 mass % of fatty acid ester Bp was mixed in the polyol dispersion oil, the Carr index decreased by approximately 4 points in each case as compared to the case of not mixing (Example 61: Carr index 78.0), but no significant adverse effect on the flowability of the soup granules was observed. Conversely, the glycerin and fat in the polyol dispersion oil were better dispersed in the polyol dispersion oil due to the emulsifying action of fatty acid ester Bp.

8. Food Product Raw Material—Salt-Based Soup powder and Curry-Based Soup Powder

The relationships between different food product raw materials and the characteristics of soup granules were investigated.

### Examples 65 to 76 and Comparative Examples 35 to 36

Soup granules were prepared by the same procedure as in Example 1, except that the food product raw material was changed to C1 (salt-based soup powder) or K1 (curry-based soup powder), the seasoning oil was changed to the corresponding salt-based seasoning oil or curry-based seasoning oil, and the spraying amount of the polyol dispersion oil was as shown in Table 9.

The details and characteristics of the soup granules of Examples 65 to 76 and Comparative Examples 35 and 36 are shown in Table 9.

TABLE 9

| | Food product | Fatty acid ester | | Polyol dispersion oil | | | | | |
|---|---|---|---|---|---|---|---|---|---|
| | raw material | Type | Blend amt | Glycerin | Seasoning oil | | Spray amt | | |
| Ex 65 | C1 | Ap | 0.84% | 9.80% | 90.20% | Salt-based | 40 | mL | 5.90% |
| Ex 66 | C1 | Ap | 0.84% | 9.80% | 90.20% | Salt-based | 60 | mL | 8.60% |
| Ex 67 | C1 | Ap | 0.84% | 9.80% | 90.20% | Salt-based | 60 | mL | 8.60% |
| Ex 68 | C1 | Ap | 0.84% | 9.80% | 90.20% | Salt-based | 60 | mL | 8.60% |
| Ex 69 | C1 | Ap | 0.84% | 9.80% | 90.20% | Salt-based | 90 | mL | 12.30% |
| Ex 70 | C1 | Ap | 0.84% | 9.80% | 90.20% | Salt-based | 90 | mL | 12.30% |
| Ex 71 | C1 | Ap | 0.84% | 9.80% | 90.20% | Salt-based | 120 | mL | 15.80% |
| Comp Ex 35 | C1 | Ap | 0.84% | 9.80% | 90.20% | Salt-based | 140 | mL | 18.00% |
| Ex 72 | K1 | Ap | 0.84% | 9.80% | 90.20% | Curry-based | 60 | mL | 8.60% |
| Ex 73 | K1 | Ap | 0.84% | 9.80% | 90.20% | Curry-based | 80 | mL | 11.10% |
| Ex 74 | K1 | Ap | 0.84% | 9.80% | 90.20% | Curry-based | 100 | mL | 13.50% |
| Ex 75 | K1 | Ap | 0.84% | 9.80% | 90.20% | Curry-based | 120 | mL | 15.80% |
| Ex 76 | K1 | Ap | 0.84% | 9.80% | 90.20% | Curry-based | 140 | mL | 18.00% |
| Comp Ex 36 | K1 | Ap | 0.84% | 9.80% | 90.20% | Curry-based | 155 | mL | 19.50% |

| | | | | Sum of angle | | |
|---|---|---|---|---|---|---|
| | | | | of repose and | | |
| | | Angle of | Angle of | angle of | | |
| | | repose | rupture | rupture | | |
| | Compressibility | [degrees] | [degrees] | [degrees] | Carr index | |
| Ex 65 | 8.92% | 39.4 | 31.6 | 71.0 | 81.0 | Excellent |
| Ex 66 | 9.57% | 42.5 | 33.3 | 75.8 | 79.0 | Excellent |
| Ex 67 | 11.10% | 42.1 | 31.9 | 74.0 | 78.5 | Excellent |
| Ex 68 | 9.50% | 40.8 | 31.4 | 72.2 | 80.0 | Excellent |
| Ex 69 | 11.51% | 41.6 | 31.0 | 72.6 | 78.0 | Excellent |
| Ex 70 | 11.17% | 43.7 | 32.4 | 76.1 | 80.5 | Excellent |
| Ex 71 | 8.44% | 45.8 | 37.2 | 83.0 | 77.5 | Excellent |
| Comp Ex 35 | 14.08% | 51.5 | 46.9 | 98.4 | 58.0 | Poor |
| Ex 72 | 12.63% | 38.9 | 30.0 | 68.9 | 79.5 | Excellent |
| Ex 73 | 13.02% | 40.0 | 29.7 | 69.7 | 81.0 | Excellent |
| Ex 74 | 11.94% | 42.2 | 33.3 | 75.5 | 74.5 | Good |
| Ex 75 | 10.95% | 41.5 | 31.5 | 73.0 | 78.5 | Excellent |
| Ex 76 | 14.40% | 46.2 | 37.1 | 83.3 | 73.0 | Good |
| Comp Ex 36 | 17.79% | 44.7 | 35.1 | 79.8 | 69.0 | OK |

Similar effects were obtained not only with the soy sauce-based soup powder and the miso-based soup powder, but also with the salt-based soup powder and the curry-based soup powder.

### 9. Oil Droplet Formation and Taste Retention After Addition of Hot Water

The characteristics of soup granules obtained from various food product raw materials and oil droplet formation of the fat and taste retention when hot water was added were investigated.

The soup granules of the following Examples were evaluated.
S1 (soy sauce-based soup powder) sprayed with 13.5 mass % polyol dispersion oil (Example 9)
S1 (soy sauce-based soup powder) sprayed with 13.5 mass % polyol dispersion oil (Example 14)
S2 (soy sauce-based soup powder) sprayed with 15.8 mass % polyol dispersion oil (Example 41)
M1 (miso-based soup powder) sprayed with 13.5 mass % polyol dispersion oil (Example 54)
C1 (salt-based soup powder) sprayed with 15.8 mass % polyol dispersion oil (Example 71)
K1 (curry soup powder) sprayed with 15.8 mass % polyol dispersion oil (Example 75)

After 60 g of noodles and 20 g of soup granules were placed into a vertical cup and the cup was sealed with a lid, it was allowed to stand for 3 weeks under a constant temperature and high humidity (temperature of 33° C., humidity of 70%) environment. The lid was opened, and 3 minutes after hot water was added, the oil droplets and taste were evaluated by five individuals in charge of the soup. The control contained seasoning oil (4 g) corresponding to the food product raw material (product).

Regarding the oil droplets, the criterion was whether or not oil droplets having a diameter of approximately 1 to 2 mm floated in the same manner as the control. The standard for taste was whether or not the taste was equivalent to that of the food product raw material (product). The oil droplets and taste were evaluated as “excellent” when five individuals judged it to be good, “good” when four people judged it to be good, “OK” when three people judged it to be good, and all others were evaluated as “poor.” The overall evaluation was determined as “excellent” when both the oil droplets and taste were “good” or better and one of them was “excellent,” “good” when both the oil droplets and taste were “good,” “OK” when at least one of the oil droplets and taste was “OK”, and “poor” otherwise. The details of crystalline substances, powdery raw materials, dextrin compounds, starches (starches and modified starches), and fatty acid esters contained in the soup granules, the amount of sprayed polyol dispersion oil, and the evaluation results are shown in Table 10.

TABLE 10

| | Food | | | | | | | | | | |
|---|---|---|---|---|---|---|---|---|---|---|---|
| | product | Soup granule ingredients | | | | | | | After addition of hot water | | |
| | raw | Crystalline | Powdery | | | | | Spray | Oil | | Overall |
| | material | substance | raw material | Dextrin | Starch | Fatty acid ester | | amt | droplets | Taste | evaluation |
| Ex 9 | S1 | 35.7% | 50.0% | 0.1% | 0 | Ap | 0.84% | 13.50% | Excellent | Excellent | Excellent |
| Ex 14 | | | | | | Bp | | | Excellent | OK | OK |
| Ex 41 | S2 | 26.9% | 49.4% | 0.0% | 7.2%¹⁾ | Ap | 0.82% | 15.80% | Excellent | Excellent | Excellent |
| Ex 54 | M1 | 33.2% | 43.3% | 0.1% | 6.90%²⁾ | Ap | 0.84% | 13.50% | Excellent | Excellent | Excellent |
| Ex 71 | C1 | 39.2% | 40.0% | 0.0% | 4.3%¹⁾ | Ap | 0.84% | 15.80% | Excellent | Excellent | Excellent |
| Ex 75 | K1 | 29.8% | 43.9% | 0.2% | 9.6%³⁾ | Ap | 0.84% | 15.80% | Good | Excellent | Excellent |

¹⁾Oxidized starch (100%)
²⁾Potato starch (100%)
³⁾Acetylated adipic acid cross-linked starch (18.6%: thickener) + phosphate cross-linked starch (11.6%) + oxidized starch (69.8%)

The fatty acid ester Ap-containing soup granules were excellent in both oil droplet formation and taste retention. The fatty acid ester Bp-containing soup granules had good oil droplet formation, but weak taste retention. Soup granules K1 (curry-based soup powder) were “good” in oil droplet formation after adding hot water. This is because the soup granules K1 had a large starch content (9.6 mass %), and the starch contained 69.8 mass % oxidized starch (improving moisture resistance) and 30.2 mass % modified starch (thickener), and thus, the oil droplets were in a state of being unlikely to float. Thus, it appears that “good” for the oil droplet formation of soup granules K1 is comparable to “excellent” for the oil droplet formation of other soup granules.

The content of dextrin compound in the soup granules was 0.5 mass % or less, and the total content of starch and modified starch was 10 mass % or less.

### 10. Production Method 3—Conical Ribbon Mixing and Drying Device

The production method of Example 1 (premix preparation, fluidized bed granulation, polyol dispersion oil spraying) corresponds to production method 1. The relationship between the type of fatty acid ester and the characteristics of the soup granules when changing the production procedure to production method 3 (first mixture preparation, second mixture preparation, and granule formation) using a conical ribbon mixing and drying device for preparing the second mixture was investigated.

### Example 77

Soup granules were prepared in accordance with the following procedure.

### <<Preparation of First Mixture>>

The first mixture was prepared by placing (D) S1 (soy sauce-based soup powder) as the food product raw material and (A) fatty acid ester Ap into a conical blender (double cone mixer WM-20, manufactured by Seiwa Giken Co., Ltd.) and mixing. The crystalline substance of the (D) food product raw material was pulverized in advance with a pulverizer. The blending ratio of Si and fatty acid ester Ap was 99.02:0.98 (mass ratio).

### <<Polyol Dispersion Oil>>

A polyol dispersion oil (glycerin concentration 9 to 10 mass %) was prepared by adding glycerin as the (B) polyol to a soy sauce-based seasoning oil as the (C) fat and stirring at a rotation speed of 400 to 450 rpm for a stirring time of 10 minutes using a tornado stirrer (product name: TORNADO, turbine type T-125, stirring shaft: 50 cm, manufactured by AS ONE Co., Ltd.). Stirring was carried out by affixing the stirring blade at the center of the tank at a height of 5 to 10 mm from the bottom of the tank, and performing the stirring at a rotation speed of 400 to 450 rpm for 10 minutes or longer so as to not generate bubbles.

### <<Preparation of Second Mixture>>

The first mixture was placed into a conical ribbon mixing and drying device (Ribocon RM-lOD, manufactured by Okawara Mfg. Co., Ltd.) and stirred at a frequency of 70 Hz. The second mixture was prepared by placing the polyol dispersion oil immediately after preparation into a container having a hole with a diameter of 1.0 to 4.0 mm at the bottom, dropping it into the first mixture for 2.5 minutes and mixing, and removing the mixture from the conical ribbon mixing and drying device 5 minutes after the start of dropping. The content of polyol dispersion oil in the second mixture was 15.5 mass %. The second mixture was obtained as soft granules due to entrapment of the powder raw material in the glycerin particles in the polyol dispersion oil. The second mixture was sieved through a 16-mesh (opening 0.9 to 1.0 mm) sieve to promote suspension in the next step of fluidized bed granulation and to suppress blocking between particles.

### <<Fluidized Bed Granulation>>

The second mixture was placed onto the perforated plate of a fluidized bed coating device (flow coater, manufactured by Okawara Mgf Co., Ltd.). The intake (air supply) temperature was set to 80 to 95° C., the damper opening was set to 0.2 to 0.4 MPa, and the spray air pressure was set to 0.18 MPa, and after the exhaust temperature reached 55° C. while suspending the second mixture, the powder was liquid-crosslinked (or coated) by spraying a 0.3 mass % aqueous solution of a thickening agent (guar gum, Orno SY-1, manufactured by Organo Foodtech Co., Ltd.) from a nozzle, and drying for 4 to 6 minutes, and after cooling to room temperature, granules having good flowability were formed. A sieve (TESTING SIEVE (opening 2 mm, wire diameter 0.9 mm), manufactured by Tokyo Screen Co., Ltd.) was used to remove large-sized granules.

### Comparative Example 37

Soup granules were prepared by the same procedure as in Example 77, except that no fatty acid ester was used.

### Examples 78 to 81 and Comparative Example 38

Soup granules were prepared by the same procedure as in Example 77, except that the fatty acid ester was changed as shown in Table 11.

The details and characteristics of the soup granules of Examples 77 to 81 and Comparative Examples 37 to 38 are shown in Table 11.

TABLE 11

| | Second mixture | | | | | | | | Thickener aqueous | |
|---|---|---|---|---|---|---|---|---|---|---|
| | First mixture (600 g) | | | | | | | | solution | |
| | Food product | Fatty acid ester | | Polyol dispersion oil | | | | | Rotary pump | |
| | raw material | Type | Blend amt | Glycerin | Seasoning oil | | Blend amt | | Spray amt | Scale |
| Comp Ex 37 | S1 | — | 0.98% | 9.80% | 90.20% | Soy sauce-based | 110 g | 15.50% | 35 mL | 4.5 |
| Ex 77 | S1 | Ap | 0.98% | 9.80% | 90.20% | Soy sauce-based | 110 g | 15.50% | 35 mL | 4.5 |
| Ex 78 | S1 | Bp | 0.98% | 9.80% | 90.20% | Soy sauce-based | 110 g | 15.50% | 35 mL | 4.5 |
| Ex 79 | S1 | Cp | 0.98% | 9.80% | 90.20% | Soy sauce-based | 110 g | 15.50% | 35 mL | 4.5 |
| Ex 80 | S1 | Ds | 0.98% | 9.80% | 90.20% | Soy sauce-based | 110 g | 15.50% | 35 mL | 4.5 |
| Ex 81 | S1 | Es | 0.98% | 9.80% | 90.20% | Soy sauce-based | 110 g | 15.50% | 35 mL | 4.5 |
| Comp Ex 38 | S1 | Fp | 0.98% | 9.80% | 90.20% | Soy sauce-based | 110 g | 15.50% | 35 mL | 4.5 |

| | Soup granule physical properties | | | | | |
|---|---|---|---|---|---|---|
| | | Angle of repose | Angle of rupture | Sum of angle of repose and | | |
| | Compressibility | [degrees] | [degrees] | angle of rupture [degrees] | Carr index | |
| Comp Ex 37 | 6.96% | 45.0 | 38.2 | 83.2 | 74.8 | Good |
| Ex 77 | 7.78% | 39.2 | 31.5 | 70.7 | 81.0 | Excellent |
| Ex 78 | 6.89% | 43.7 | 33.9 | 77.6 | 80.0 | Excellent |
| Ex 79 | 12.64% | 45.5 | 34.6 | 80.1 | 75.5 | Excellent |
| Ex 80 | 8.97% | 43.0 | 37.8 | 80.8 | 73.0 | Good |
| Ex 81 | 4.43% | 42.8 | 37.0 | 79.8 | 79.0 | Excellent |
| Comp Ex 38 | 12.66% | 45.8 | 39.8 | 85.6 | 68.5 | OK |

The details and characteristics of the soup granules of Examples 10, 15, and 20 produced by production method 1 are shown again in Table 12.

TABLE 12

| | Food product | Fatty acid ester | | Polyol dispersion oil | | | | |
|---|---|---|---|---|---|---|---|---|
| | raw material | Type | Blend amt | Glycerin | Seasoning oil | | Spray amt | |
| Ex 10 | S1 | Ap | 0.84% | 9.80% | 90.20% | Soy sauce-based | 120 mL | 15.80% |
| Ex 15 | S1 | Bp | 0.84% | 9.80% | 90.20% | Soy sauce-based | 120 mL | 15.80% |
| Ex 20 | S1 | Cp | 0.84% | 9.80% | 90.20% | Soy sauce-based | 80 mL | 11.10% |

| | | Angle of repose | Angle of rupture | Sum of angle of repose and | | |
|---|---|---|---|---|---|---|
| | Compressibility | [degrees] | [degrees] | angle of rupture [degrees] | Carr index | |
| Ex 10 | 13.41% | 48.0 | 35.7 | 83.7 | 71.0 | Good |
| Ex 15 | 11.91% | 42.7 | 36.4 | 79.1 | 71.0 | Good |
| Ex 20 | 7.36% | 42.6 | 37.6 | 80.2 | 73.0 | Good |

It is believed that production method 3 (Table 11) promotes more effective semi-solidification or solidification of the fat by the glycerin in the polyol dispersion oil as compared to production method 1 (Table 12). This is suggested by the fact that the Carr index of the soup granules obtained by production method 3 is generally greater than the Carr index of the soup granules obtained by production method 1. As the reason why the semi-solidification or solidification of the fat by the glycerin in production method 3 progressed more effectively, it is believed that the first mixture containing the food product raw material and the fatty acid ester and the polyol dispersion oil were mixed more uniformly without the formation of clumps. Furthermore, the sum of the angle of repose and the angle of rupture in each of Examples 77 to 81 was 82 degrees or less, smaller than those in Comparative Examples 37 and 38.

According to production method 3, operating efficiency can be improved and the properties of the obtained soup granules can also be improved. Furthermore, according to production method 3, contamination of piping tubes, perforated plates, bag filters, etc., with the polyol dispersion oil and the cleaning of these parts after operations associated with spraying the polyol dispersion oil in production method 1 can be prevented.

### 11. Production Method 3—Pin Type Mixer

In production method 3, the relationship between the workability when using a pin-type mixer to prepare the second mixture and the characteristics of the obtained soup granules was investigated.

### Examples 82 to 86

Soup granules were prepared by the same procedure as in Example 77, except that the food product raw material was changed to C1 (salt-based soup powder) and a pin-type mixer was used to prepare the second mixture. Specifically, the mixing using the pin-type mixer was as follows.

### <<Pin Type Mixer Mixing>>

The first mixture was placed into a pin-type mixer (manufactured by Youdamenki Seisakusho, mixer wave device, (model) 5, (manufactured) September 2004, product number 05) and stirred at a rotation speed of 70 rpm. Immediately after preparing the polyol dispersion oil, the polyol dispersion oil was placed in a container having a hole with a diameter of 1.0 to 4.0 mm at the bottom, and added dropwise to the first mixture for 2.5 minutes and mixed, and after 5 minutes from the start of dropping, the mixture was taken out from the conical ribbon mixing and drying device to prepare the second mixture. The second mixture was obtained as soft granules due to entrapment of the powder raw material in the glycerin particles in the polyol dispersion oil. The second mixture was sieved through a 16-mesh (opening 0.9 to 1.0 mm) sieve to promote suspension in the next step of fluidized bed granulation and to suppress blocking between particles.

The details and characteristics of the soup granules of Examples 82 to 86 are shown in Table 13.

TABLE 13

| | Second mixture | | | | | | | | Thickener aqueous | |
|---|---|---|---|---|---|---|---|---|---|---|
| | First mixture (600 g) | | | | | | | | solution | |
| | Food product | Fatty acid ester | | Polyol dispersion oil | | | | | Rotary pump | |
| | raw material | Type | Blend amt | Glycerin | Seasoning oil | | Blend amt | | Spray amt | Scale |
| Ex 82 | C1 | Ap | 0.98% | 9.80% | 90.20% | salt-based | 50 g | 7.70% | 35 mL | 2.0 |
| Ex 83 | C1 | Ap | 0.98% | 9.80% | 90.20% | salt-based | 50 g | 7.70% | 35 mL | 4.5 |
| Ex 84 | C1 | Ap | 0.98% | 9.80% | 90.20% | salt-based | 80 g | 11.70% | 35 mL | 4.5 |
| Ex 85 | C1 | Ap | 0.98% | 9.80% | 90.20% | salt-based | 90 g | 13.00% | 35 mL | 4.5 |
| Ex 86 | C1 | Ap | 0.98% | 9.80% | 90.20% | salt-based | 110 g | 15.50% | 35 mL | 4.5 |

| | Soup granule physical properties | | | | | |
|---|---|---|---|---|---|---|
| | | Angle of repose | Angle of rupture | Sum of angle of repose and | | |
| | Compressibility | [degrees] | [degrees] | angle of rupture [degrees] | Carr index | |
| Ex 82 | 11.88% | 45.7 | 32.4 | 78.1 | 75.5 | Excellent |
| Ex 83 | 9.55% | 38.5 | 28.7 | 67.2 | 84.0 | Excellent |
| Ex 84 | 8.98% | 38.7 | 29.6 | 68.3 | 84.0 | Excellent |
| Ex 85 | 10.74% | 39.4 | 29.4 | 68.8 | 84.0 | Excellent |
| Ex 86 | 10.39% | 38.9 | 29.8 | 68.7 | 83.5 | Excellent |

The pin-type mixer comprises a stirring rod extending along the central axis of a horizontally elongated stirring vessel with a shallow bottom, and the stirring rod is provided with a plurality of pins extending in eight directions from the central axis. Though the pin-type mixer is a simple mixing device, a uniformly mixed second mixture could be obtained. In addition, since the outlet of the pin-type mixer was wide, the second mixture was easily discharged, and the operations leading to fluidized bed granulation in the next step could be smoothly carried out.

Regarding the spraying of the thickener aqueous solution during fluidized bed granulation, comparing Examples 82 and 83, increasing the pressure scale of the rotary pump from 2.0 to 4.5 (increased delivery pressure) improved the compressibility, the sum of the angle of repose and the angle of rupture, and the Carr index.

For premix fluidized bed granulation containing food product raw material and fatty acid ester as in Example 1, while the spraying amount of the thickener aqueous solution was about 80 mL, in the case of fluidized bed granulation of the second mixture, the spraying amount of the thickener aqueous solution was as small as 35 mL. A possible reason for this is that the presence of water-soluble glycerin in the second mixture makes it easier for the thickener aqueous solution to adhere to the second mixture.

From Examples 82 to 86, even when the blending amount of the polyol dispersion oil was changed from 7.7 mass % to 15.5 mass %, soup granules with approximately equal compressibility, sum of angle of repose and angle of rupture, and Carr index could be obtained.

### 12. Addition of Paste-Like Seasoning or Extract—Miso

The characteristics of soup granules when a paste-like seasoning or extract was added to the polyol dispersion oil were investigated.

### Examples 87 to 96

Soup granules were obtained by the same procedure as in Example 82, except that the food product raw material was changed to M1 (miso-based soup powder), and a polyol dispersion oil containing miso-based seasoning oil, sesame paste (examples 91 to 93 only), and miso and pork extract (examples 94 to 96 only) was used.

A polyol dispersion oil was prepared by the following procedure. Glycerin was added as the (B) polyol to a mixture containing miso-based seasoning oil and sesame paste (only Examples 91 to 93) as the (C) fat, and then miso and pork extracts were further added thereto (only Examples 94 to 96), and using a tornado stirrer (product name: TORNADO, turbine type T-125, stirring shaft 50 cm, manufactured by AS ONE Co., Ltd.), the mixture was stirred at a rotation speed of 400 to 450 rpm and a stirring time of 10 minutes to prepare a polyol dispersion oil (glycerin concentration 9 to 10 mass %). Stirring was carried out by affixing the stirring blade at the center of the tank at a height of 5 to 10 mm from the bottom of the tank, and performing the stirring at a rotation speed of 400 to 450 rpm for 10 minutes or longer so as to not generate bubbles.

The details and characteristics of the soup granules of Examples 87 to 93 are shown in Table 14, and the details and characteristics of the soup granules of Examples 94 to 96 are shown in Table 15.

TABLE 14

| | Second mixture | | | | | | | | | | | Thickener aqueous | |
|---|---|---|---|---|---|---|---|---|---|---|---|---|---|
| | First mixture (600 g) | | | | | | | | | | | solution | |
| | | Fatty acid ester | | Polyol dispersion oil | | | | | | | | Rotary pump | |
| | Food product | | Blend | | | | Sesame | | | Liquid | | Spray | |
| | raw material | Type | amt | Glycerin | Seasoning oil | | paste | Blend amt | | part % | Fat % | amt | Scale |
| Ex 87 | M1 | Ap | 0.98% | 9.80% | 90.20% | Miso-based | — | 60 | g | 9.10% | | 45 mL | 4.5 |
| Ex 88 | M1 | Ap | 0.98% | 9.80% | 90.20% | Miso-based | — | 90 | g | 13.00% | | 45 mL | 4.5 |
| Ex 89 | M1 | Ap | 0.98% | 9.80% | 90.20% | Miso-based | — | 120 | g | 16.70% | | 45 mL | 4.5 |
| Ex 90 | M1 | Ap | 0.98% | 9.80% | 90.20% | Miso-based | — | 150 | g | 20.00% | | 45 mL | 4.5 |
| Ex 91*) | M1 | Ap | 0.98% | 5.00% | 10.00% | Miso-based | 85.00% | 200 | g | 25.00% | 16.10% | 45 mL | 4.5 |
| Ex 92*) | M1 | Ap | 0.98% | 5.00% | 15.00% | Miso-based | 80.00% | 200 | g | 25.00% | 16.60% | 45 mL | 4.5 |
| Ex 93*) | M1 | Ap | 0.98% | 5.00% | 20.00% | Miso-based | 75.00% | 200 | g | 25.00% | 17.10% | 45 mL | 4.5 |

| | Soup granule physical properties | | | | | |
|---|---|---|---|---|---|---|
| | | | | Sum of angle of repose | | |
| | | Angle of repose | Angle of rupture | and angle of rupture | | |
| | Compressibility | [degrees] | [degrees] | [degrees] | Carr index | |
| Ex 87 | 7.78% | 38.0 | 31.7 | 69.7 | 79.0 | Excellent |
| Ex 88 | 10.86% | 40.7 | 34.1 | 74.8 | 76.3 | Excellent |
| Ex 89 | 9.00% | 39.0 | 34.4 | 73.4 | 76.0 | Excellent |
| Ex 90 | 8.34% | 42.5 | 37.2 | 79.7 | 73.0 | Good |
| Ex 91*) | 5.23% | 39.1 | 32.1 | 71.2 | 82.3 | Excellent |
| Ex 92*) | 4.72% | 38.0 | 30.9 | 68.9 | 80.6 | Excellent |
| Ex 93*) | 5.78% | 37.9 | 32.1 | 70.0 | 79.0 | Excellent |

*)The weight % of the fat was calculated assuming half the amount of the sesame paste as fat content.

TABLE 15

| | Second mixture | | | | | | | | | | | Thickener aqueous | |
|---|---|---|---|---|---|---|---|---|---|---|---|---|---|
| | First mixture (600 g) | | | | | | | | | | | solution | |
| | | Fatty acid ester | | Polyol dispersion oil | | | | | | | | Rotary pump | |
| | Food | | | | | | | | Total of | | | | |
| | product | | | | | | | | water, | | | | |
| | raw | | Blend | | | | | Pork | alcohol, | Blend | | Spray | |
| | material | Type | amt | Glycerin | Seasoning oil | | Miso | extract | and salt | amt | Fat % | amt | Scale |
| Ex 94 | M1 | Ap | 0.98% | 10.0% | 25.0% | Miso-based | 30.0% | 20.0% | 15.0% | 90 g | 13.00% | 45 mL | 4.5 |
| Ex 95 | M1 | Ap | 0.98% | 12.5% | 22.5% | Miso-based | 30.0% | 20.0% | 15.0% | 90 g | 13.00% | 45 mL | 4.5 |
| Ex 96 | M1 | Ap | 0.98% | 15.0% | 20.0% | Miso-based | 30.0% | 20.0% | 15.0% | 90 g | 13.00% | 45 mL | 4.5 |

| | Soup granule physical properties | | | | | |
|---|---|---|---|---|---|---|
| | | | | Sum of angle of repose | | |
| | | Angle of repose | Angle of rupture | and angle of rupture | | |
| | Compressibility | [degrees] | [degrees] | [degrees] | Carr index | |
| Ex 94 | 8.47% | 37.6 | 28.1 | 65.7 | 85.0 | Excellent |
| Ex 95 | 7.04% | 37.7 | 27.6 | 65.3 | 85.0 | Excellent |
| Ex 96 | 5.39% | 36.8 | 27.4 | 64.2 | 87.5 | Excellent |

In Examples 91 to 93 of Table 14, the mass % of the fat was calculated by considering half of the amount of the sesame paste as oil content. In Examples 94 to 96 of Table 15, the miso (water content: 40 mass %) and pork extract were mixed, the polyol dispersion oil was then heated to 80° C. in a hot water bath and then mixed with the first mixture. The salt content of the polyol dispersion oil (90 g) was set at 8 mass % or more and the alcohol content was set at 2.5 mass % or more in accordance with food microbial control.

A particularly high Carr index was obtained in Examples 91 and 92 as compared to Examples 87 to 90. This is presumably because by using a large amount of sesame paste as in Examples 91 and 92, solid content other than the sesame oil (such as ash) assisted the uniform dispersion of glycerin in polyol dispersion oil and suppressed the separation of the glycerin and the fat over time, and as a result, the first mixture and the polyol dispersion oil were more uniformly mixed.

According to an embodiment of the present invention, as shown in Examples 91 to 96, an extract or paste-like seasoning such as sesame paste, miso, or pork extract integrated with the soup granules (in one portion) can be provided.

### 13. Addition of Paste-Like Seasoning or Extract—Curry-Based

The characteristics of soup granules when a paste-like seasoning was added to the polyol dispersion oil were investigated.

### Examples 97 to 99

Soup granules were prepared by the same procedure as in Example 82, except that the food product raw material was changed to K1 (curry-based soup powder), and a curry-based seasoning oil and a polyol dispersion oil containing curry roux (dissolved evenly in a hot water bath) were used.

A polyol dispersion oil was prepared by the following procedure. Glycerin was added as the (B) polyol to a mixture containing curry seasoning oil, lard, and curry roux as (C) the fat, and the mixture was stirred in a hot water bath at 60 to 90° C. at a rotation speed of 400 to 450 rpm and a stirring time of 10 minutes using a tornado stirrer (product name: TORNADO, turbine type T-125, stirring shaft 50 cm, manufactured by AS ONE Co., Ltd.) to prepare a polyol dispersion oil (glycerin concentration 3 to 5 mass %). Stirring was carried out by affixing the stirring blade at the center of the tank at a height of 5 to 10 mm from the bottom of the tank, and performing the stirring at a rotation speed of 400 to 450 rpm for 10 minutes or longer so as to not generate bubbles.

The details and characteristics of the soup granules of Examples 97 to 99 are shown in Table 16.

TABLE 16

| | Second mixture | | | | | | | | | | Thickener | |
|---|---|---|---|---|---|---|---|---|---|---|---|---|
| | | | | | | | | | | | aqueous solution | |
| | First mixture (600 g) | | | Polyol dispersion oil | | | | | | | Rotary pump | |
| | Food product | Fatty acid ester | | | | | Curry | | | | Spray | |
| | raw material | Type | Blend amt | Glycerin | Seasoning oil | | roux | Blend amt | Fat amt | Fat %*) | amt | Scale |
| Ex 97 | K1 | Ap | 0.98% | 5.0% | 30.0% | Curry-based | 65.0% | 200 g | 70 g | 8.75% | 45 mL | 4.5 |
| Ex 98 | K1 | Ap | 0.98% | 4.0% | 31.0% | Curry-based | 65.0% | 200 g | 70 g | 8.75% | 45 mL | 4.5 |
| Ex 99 | K1 | Ap | 0.98% | 3.0% | 32.0% | Curry-based | 65.0% | 200 g | 70 g | 8.75% | 45 mL | 4.5 |

| | Soup granule physical properties | | | | | |
|---|---|---|---|---|---|---|
| | | Angle of repose | Angle of rupture | Sum of angle of repose and angle of | | |
| | Compressibility | [degrees] | [degrees] | rupture [degrees] | Carr index | |
| Ex 97 | 9.26% | 35.4 | 27.5 | 62.9 | 86.0 | Excellent |
| Ex 98 | 10.93% | 37.0 | 28.2 | 65.2 | 83.5 | Excellent |
| Ex 99 | 9.74% | 39.4 | 30.0 | 69.4 | 83.5 | Excellent |

*)The fat contained in the curry roux is not included in the mass % of fat.

In Examples 97 to 99 of Table 16, the concentration of the curry roux in the polyol dispersion oil was as high as 65 mass %. In addition, in Table 16, the fat content contained in the curry roux is not included in the fat mass %.

As shown in Examples 97 to 99, according to one embodiment of the present invention, a highly viscous paste-like seasoning such as curry roux integrated with the soup granules (in one portion) can be provided.

### INDUSTRIAL APPLICABILITY

Since the granular food product of the present disclosure contains a high concentration of fat and optionally an extract or paste-like seasoning while having a high flowability suitable for container filling, and can form fat oil droplets when hot water is added, it can be suitably used for, for example, soup granules. Soup granules, for example, can reduce an environmental impact by reducing individual packaging of a seasoning oil and an extract or paste-like seasoning, reduce manufacturing costs by reducing additional packaging materials and man-hours, and reproduce the oil droplets and taste of seasoning oil simply by pouring hot water.

1. A method for the production of a granular food product, comprising:
forming a granulated substance by granulating a mixture of (A) at least one fatty acid ester selected from the group consisting of a (poly)glycerin fatty acid ester having an average degree of polymerization of glycerin moieties of 1 to 8 and having a hydrophilic-lipophilic balance (HLB) of 6 or less, and a sucrose fatty acid ester having an HLB of 6 or less, and (D) a food product raw material, and
spraying a polyol dispersion oil containing (B) a polyol and (C) a fat onto the granulated substance,
wherein the polyol is glycerin, and wherein the (poly)glycerin fatty acid ester has a fatty acid moiety of 16 to 22 carbon atoms.

2. A method for the production of a granular food product, comprising:
forming a granulated substance by granulating (D) a food product raw material, and
spraying a polyol dispersion oil containing (A) at least one fatty acid ester selected from the group consisting of a (poly)glycerin fatty acid ester having an average degree of polymerization of glycerin moieties of 1 to 8 and having a hydrophilic-lipophilic balance (HLB) of 6 or less, and a sucrose fatty acid ester having an HLB of 6 or less, (B) a polyol, and (C) a fat onto the granulated substance,
wherein the polyol is glycerin, and wherein the (poly)glycerin fatty acid ester has a fatty acid moiety of 16 to 22 carbon atoms.

3. A method for the production of a granular food product, comprising:
preparing a first mixture of (A) at least one fatty acid ester selected from the group consisting of a (poly)glycerin fatty acid ester having an average degree of polymerization of glycerin moieties of 1 to 8 and having a hydrophilic-lipophilic balance (HLB) of 6 or less, and a sucrose fatty acid ester having an HLB of 6 or less, and (D) a food product raw material,
preparing a second mixture of a polyol dispersion oil containing (B) a polyol and (C) a fat and the first mixture, and
forming a granulated substance by granulating the second mixture,
wherein the polyol is glycerin, and wherein the (poly)glycerin fatty acid ester has a fatty acid moiety of 16 to 22 carbon atoms.

4. The method for the production of a granular food product according to claim 3, wherein the polyol dispersion oil further contains at least one additive selected from the group consisting of an extract and a paste-like seasoning.

5. The method for the production of a granular food product according to claim 1, wherein the (poly)glycerin fatty acid ester contains a mixture of a monoglycerin fatty acid ester and a polyglycerin fatty acid ester.

6. The method for the production of a granular food product according to claim 2, wherein the (poly)glycerin fatty acid ester contains a mixture of a monoglycerin fatty acid ester and a polyglycerin fatty acid ester.

7. The method for the production of a granular food product according to claim 3, wherein the (poly)glycerin fatty acid ester contains a mixture of a monoglycerin fatty acid ester and a polyglycerin fatty acid ester.

8. The method for the production of a granular food product according to claim 1, wherein the sucrose fatty acid ester has a fatty acid moiety of 16 to 22 carbon atoms.

9. The method for the production of a granular food product according to claim 2, wherein the sucrose fatty acid ester has a fatty acid moiety of 16 to 22 carbon atoms.

10. The method for the production of a granular food product according to claim 3, wherein the sucrose fatty acid ester has a fatty acid moiety of 16 to 22 carbon atoms.

11. The method for the production of a granular food product according to claim 1, wherein the sucrose fatty acid ester contains at least one selected from the group consisting of sucrose palmitate and sucrose stearate.

12. The method for the production of a granular food product according to claim 2, wherein the sucrose fatty acid ester contains at least one selected from the group consisting of sucrose palmitate and sucrose stearate.

13. The method for the production of a granular food product according to claim 3, wherein the sucrose fatty acid ester contains at least one selected from the group consisting of sucrose palmitate and sucrose stearate.
